(19) United States
(12) Patent Application Publication
(10) Pub. No.: US 2026/0234500 A1
(43) Pub. Date: Aug. 13, 2026

(54) HIGH PERFORMANCE WIND TURBINE GEAR OILS AND RELATED METHODS

(71) Applicant: EXXONMOBIL TECHNOLOGY AND ENGINEERING COMPANY, Spring, TX (US)

(72) Inventors: Reda K. FAWZY, Houston, TX (US); Michael L. BLUMENFELD, Annandale, NJ (US)

(73) Assignee: EXXONMOBIL TECHNOLOGY AND ENGINEERING COMPANY, Spring, TX (US)

(21) Appl. No.: 19/538,900

(22) Filed: Feb. 12, 2026

Related U.S. Application Data
(60) Provisional application No. 63/757,947, filed on Feb. 13, 2025.

(51) Int. Cl. C10M 171/02; C10M 105/74; C10M 111/04; C10M 141/08; C10M 141/10; C10N 20/02; C10N 30/02; C10N 40/04; C10N 40/25; F03D 15/10

(52) U.S. Cl. CPC C10M 171/02; C10M 105/74; C10M 111/04; C10M 141/08; C10M 141/10; F03D 15/10; C10N 2020/02; C10N 2030/02; C10N 2040/04; C10N 2040/252

(57) ABSTRACT

Wind turbine gear oil compositions and methods of making the same. Wind turbine gear oil compositions may comprise: a base oil comprising a Group II/II+ extra heavy neutral oil base stock and a Group III/III+ oil base stock and/or a Group V oil base stock; and a performance additive package, where the wind turbine gear oil composition exhibits, as compared to a corresponding wind turbine gear oil composition wherein all of the Group II/II+ extra heavy neutral oil base stock is replaced with a Group IV oil base stock and optionally a Group III/III+ oil base stock and/or a Group V oil base stock, a property selected from the group consisting of: equivalent or reduced copper corrosion, rust formation, pour point, foaming, oxidation; equivalent or increased demulsibility; and any combination thereof.

### FIELD OF THE DISCLOSURE

This application relates to lubricant oil compositions having improved oil life and energy efficiency and, more particularly, to wind turbine gear oil compositions and methods of use thereof.

### BACKGROUND

Base oils are a major constituent in industrial oils and contribute significantly to the final properties of these products, such as low temperature performance, biodegradability, energy efficiency, and high temperature oxidation stability. Each base oil possesses distinct characteristics that are needed to satisfy the specific operation requirements of a particular industrial oil composition.

Wind turbine gear oils, for example, are oils that are used as lubricants in wind turbine gears to reduce friction and wear to enable parts to move smoothly. Wind turbine gear oils contain two general components, namely, one or more oil base stocks and additives. Wind turbine gear oils require exceptional oil life, often tens of thousands of hours, as well as high energy efficiency, both high fluidity at low temperatures and high film thickness at high temperatures. There is a desire to improve the oil life by improving the oil oxidative and shear stability, as well as to improve the oil energy efficiency by reducing the oil coefficient of traction. By improving the energy efficiency of and by extending the life of wind turbine gear oils, significant sustainability benefits in energy savings and reduced oil waste can be achieved.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a wind turbine gear oil composition includes: a base oil comprising a Group II/II+ extra heavy neutral oil base stock and a Group III/III+ oil base stock and/or a Group V oil base stock; and a performance additive package, wherein the wind turbine gear oil composition exhibits one or more of the following, as compared to a corresponding wind turbine gear oil composition wherein at least a portion of or all of the Group II/II+ extra heavy neutral oil base stock is replaced with a Group IV oil base stock and optionally a Group III/III+ oil base stock and/or a Group V oil base stock: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or decreased wearing, determined by DIN ISO 14635-1 or DIN 51819-3; and equivalent or reduced oxidation, as determined by DIN EN ISO 4263-4.

According to another embodiment consistent with the present disclosure, a wind turbine gear oil composition includes a base oil comprising a Group II/II+ extra heavy neutral oil base stock and an additional oil base stock selected from a Group III/III+ oil base stock and/or a Group V oil base stock, and a performance additive package; wherein the wind turbine gear oil composition exhibits, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

According to an additional embodiment consistent with the present disclosure, a wind turbine gear oil composition includes a base oil comprising a Group II/II+ extra heavy neutral oil base stock and an additional oil base stock selected from a Group III/III+ oil base stock and/or a Group V oil base stock, and a performance additive package; wherein: the Group II/II+ extra heavy neutral oil base stock is present in the wind turbine gear oil composition at from about 5 wt % to about 98 wt %; the Group III/III+ oil base stock is present in the wind turbine gear oil composition at from about 10 wt % to about 40 wt % and/or the Group V oil base stock is present in the wind turbine gear oil composition at from 1 wt % to about 10 wt %; the performance additive package is present in the wind turbine gear oil composition at from about 1 wt % to about 5 wt %; and the wind turbine gear oil composition exhibits, as compared to a corresponding wind turbine gear oil composition wherein at least 60% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

According to a further embodiment consistent with the present disclosure, a method for producing a wind turbine gear oil composition having low-temperature fluidity and/or oxidation stability includes: providing a base oil for a wind turbine gear oil composition, the base oil comprising a Group II/II+ extra heavy neutral oil base stock and a Group III/III+ oil base stock and/or a Group V oil base stock; optionally, providing a performance additive package; and optionally, blending the base oil with a performance additive package, thereby forming a wind turbine gear oil composition exhibiting one or more of the following, as compared to a corresponding wind turbine gear oil composition wherein all of the Group II/II+ extra heavy neutral oil base stock is replaced with a Group IV oil base stock and optionally a Group III/III+ oil base stock and/or a Group V oil base stock: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or decreased wearing, determined by DIN ISO 14635-1 or DIN 51819-3; and equivalent or reduced oxidation, as determined by DIN EN ISO 4263-4.

According to yet a further embodiment consistent with the present disclosure, a method for producing a wind turbine gear oil composition includes providing a base oil for a wind turbine gear oil composition, the base oil comprising a Group II/II+ extra heavy neutral oil base stock and an additional oil base stock selected from a Group III/III+ oil base stock and/or a Group V oil base stock; optionally, providing a performance additive package; and optionally, blending the base oil with a performance additive package, thereby forming a wind turbine gear oil composition exhibiting, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

According to still an additional embodiment consistent with the present disclosure, a method for producing a wind turbine gear oil composition includes providing a base oil for a wind turbine gear oil composition, the base oil comprising a Group II/II+ extra heavy neutral oil base stock and an additional oil base stock selected from a Group III/III+ oil base stock and/or a Group V oil base stock; providing a performance additive package; and blending the base oil with the performance additive package, thereby forming a wind turbine gear oil composition, wherein: the Group II/II+ extra heavy neutral oil base stock is present in the wind turbine gear oil composition at from about 5 wt % to about 98 wt %; the Group III/III+ oil base stock is present in the wind turbine gear oil composition at from about 10 wt % to about 40 wt % and/or the Group V oil base stock is present in the wind turbine gear oil composition at from 1 wt % to about 10 wt %; the performance additive package is present in the wind turbine gear oil composition at from about 1 wt % to about 5 wt %; and the wind turbine gear oil composition exhibits, as compared to a corresponding wind turbine gear oil composition wherein at least 60% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

Any combinations of the various embodiments and implementations disclosed herein can be used in a further embodiment, consistent with the disclosure. These and other features and attributes of the disclosed compositions and methods of the present disclosure and their advantageous applications and/or uses will be apparent from the detailed description which follows.

### BRIEF DESCRIPTION OF THE DRAWINGS

Not Applicable.

### DETAILED DESCRIPTION

This application relates to compositions suitable as lubricants and, more particularly for use as wind turbine gear oils, and methods concerning the same.

The present disclosure provides wind turbine gear oil compositions comprising at least one Group II/II+ extra heavy neutral oil base stock. The wind turbine gear oil compositions described herein advantageously perform lubrication in wind turbine gears to reduce friction and wear to enable parts to move smoothly to the same level of more costly corresponding compositions comprising typical oil base stocks (e.g., poly-α-olefin (PAO) oil base stocks (including conventional PAO and metallocene PAO (mPAO) oil base stocks), coal-to-liquid (CTL) oil base stocks, gas-to-liquid (GTL) oil base stocks, or ethylene-α-olefin copolymer (EAO) oil base stocks). Accordingly, the described wind turbine gear oils provide significant advantages in areas of oil life and energy efficiency without compromising performance.

Wind turbine gear oils of the present disclosure may further provide equivalent or improved low-temperature fluidity, oxidation stability, corrosion resistance, foaming resistance, water separability, and/or wear resistance, as compared to typical wind turbine gear oil compositions (e.g., PAO-based, CTL-based, GTL-based, or EAO-based wind turbine gear oil compositions). Unexpectedly, the wind turbine gear oils of the present disclosure further achieve industry standards and regulations, the benefits listed hereinabove, without sacrificing performance or cleanliness. Further, and unexpectedly, the described wind turbine gear oil shows equivalent or improved properties not previously attainable by oil base stocks other than Group IV and Group V oil base stocks.

Accordingly, in an aspect, the present disclosure provides wind turbine gear oil compositions comprising a base oil and a performance additive package, where the base oil comprises a Group II/II+ extra heavy neutral oil base stock and a Group III/III+ oil base stock and/or a Group V oil base stock, and wherein the wind turbine gear oil composition exhibits one or more of the following, as compared to a corresponding wind turbine gear oil composition wherein all of the Group II/II+ extra heavy neutral oil base stock is replaced by a Group IV oil base stock and optionally a Group III/III+ oil base stock and/or a Group V oil base stock: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or decreased wearing, determined by DIN ISO 14635-1 or DIN 51819-3; and equivalent or reduced oxidation, as determined by DIN EN ISO 4263-4.

In another aspect, the present disclosure provides wind turbine gear oil compositions comprising a base oil comprising a Group II/II+ extra heavy neutral oil base stock and an additional oil base stock selected from a Group III/III+ oil base stock and/or a Group V oil base stock, and a performance additive package; wherein the wind turbine gear oil composition exhibits, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

In another aspect, the present disclosure provides wind turbine gear oil compositions, comprising: a base oil comprising a Group II/II+ extra heavy neutral oil base stock and an additional oil base stock selected from a Group III/III+ oil base stock and/or a Group V oil base stock, and a performance additive package; wherein: the Group II/II+ extra heavy neutral oil base stock is present in the wind turbine gear oil composition at from about 5 wt % to about 98 wt %; the Group III/III+ oil base stock is present in the wind turbine gear oil composition at from about 10 wt % to about 40 wt % and/or the Group V oil base stock is present in the wind turbine gear oil composition at from 1 wt % to about 10 wt %; the performance additive package is present in the wind turbine gear oil composition at from about 1 wt % to about 5 wt %; and the wind turbine gear oil composition exhibits, as compared to a corresponding wind turbine gear oil composition wherein at least 60% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

In another aspect, the present disclosure provides methods for producing a wind turbine gear oil composition exhibiting equivalent or improved performance, the methods comprising: providing a base oil for a wind turbine gear oil composition, the base oil comprising a Group II/II+ extra heavy neutral oil base stock and a Group III/III+ oil base stock and/or a Group V oil base stock; and optionally, blending the base oil with a performance additive package, thereby forming a wind turbine gear oil composition exhibiting one or more of the following, as compared to a corresponding wind turbine gear oil composition wherein at least a portion of or all of the Group II/II+ extra heavy neutral oil base stock is replaced by a Group IV oil base stock and optionally a Group III/III+ oil base stock and/or a Group V oil base stock: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or decreased wearing, determined by DIN ISO 14635-1 or DIN 51819-3; and equivalent or reduced oxidation, as determined by DIN EN ISO 4263-4.

In another aspect, the present disclosure provides methods for producing wind turbine gear oil compositions, the methods comprising: providing a base oil for a wind turbine gear oil composition, the base oil comprising a Group II/II+ extra heavy neutral oil base stock and an additional oil base stock selected from a Group III/III+ oil base stock and/or a Group V oil base stock; optionally, providing a performance additive package; and optionally, blending the base oil with a performance additive package, thereby forming a wind turbine gear oil composition exhibiting, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

In another aspect, the present disclosure provides methods for producing a wind turbine gear oil compositions, the methods comprising: providing a base oil for a wind turbine gear oil composition, the base oil comprising a Group II/II+ extra heavy neutral oil base stock and an additional oil base stock selected from a Group III/III+ oil base stock and/or a Group V oil base stock; providing a performance additive package; and blending the base oil with the performance additive package, thereby forming a wind turbine gear oil composition, wherein: the Group II/II+ extra heavy neutral oil base stock is present in the wind turbine gear oil composition at from about 5 wt % to about 98 wt %; the Group III/III+ oil base stock is present in the wind turbine gear oil composition at from about 10 wt % to about 40 wt % and/or the Group V oil base stock is present in the wind turbine gear oil composition at from 1 wt % to about 10 wt %; the performance additive package is present in the wind turbine gear oil composition at from about 1 wt % to about 5 wt %; and the wind turbine gear oil composition exhibits, as compared to a corresponding wind turbine gear oil composition wherein at least 60% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

### Definitions

As used herein, the term “wt. %,” and grammatical variations thereof, refer generally to percentage (also referred to herein as “percent” or “%”) by weight. As used herein, the term “vol. %,” and grammatical variations thereof, refer generally to percentage by volume. As used herein, the term “mol %,” and grammatical variations thereof, refer generally to percentage by mole. As used herein, the term “ppm,” and grammatical variations thereof, refer generally to parts per million. As used herein, the terms “ppm wt.,” “wppm,” and grammatical variations thereof, refer generally to parts per million on a weight basis. As used herein, the term “wt. ratio,” and grammatical variations thereof, refer generally to weight ratio. As used herein, the term “vol. ratio,” and grammatical variations thereof, refer generally to volume ratio. As used herein, the term “mol ratio,” and grammatical variations thereof, refer generally to mole ratio. All concentrations herein, unless otherwise stated, are expressed on the basis of the total amount of the composition in question.

As used herein, the terms “lubricant,” “lubricating oil,” and grammatical variations thereof, refer generally to a substance (usually a fluid under operating conditions) suitable for introduction between two moving surfaces of a system to reduce the friction and wear between said surfaces.

As used herein, the term “base oil,” and grammatical variations thereof, refer generally to the fluid component of a lubricant composition or lubricating oil composition, which may comprise one or more different oil base stocks.

As used herein, the term “oil base stock,” and grammatical variations thereof, refer generally to any fluid that could be used in a base oil, including, but not limited to, a terpene, a mineral oil, a synthetic hydrocarbon, an ester, the like, or any combination thereof. An oil base stock, as described herein, may be defined according to the American Petroleum Institute (API) base oil classification system, which categorizes oil base stocks into five groups based on their saturated hydrocarbon content, sulfur level.

As used herein, the terms “viscosity index”, “VI,” and grammatical variations thereof, refer generally to an empirical, unit-less number indicating the effect of temperature change on the kinematic viscosity of the oil base stock, base oil, or lubricant composition. A higher viscosity index indicates a smaller decrease in kinematic viscosity with increasing temperature. An oil base stock, base oil, or lubricant composition may have a VI value as determined by ASTM D2270-16.

Oil base stocks are typically produced on a large scale from non-renewable petroleum sources. As used herein, the term “Group I oil base stocks,” and grammatical variations thereof, refer generally to refined crude oils which are the least refined, undergoing solvent refining, comprising less than 90% saturates and/or greater than 0.03% sulfur, and having a viscosity index (VI) of about 80-120. As used herein, the term “Group II oil base stock,” and grammatical variations thereof, refer generally to refined crude oils which are more refined than Group I oil base stocks, both solvent refined and hydrocracked, to achieve more than 90% saturates, less than 0.03% sulfur, and having a viscosity index (VI) of about 80-120. As used herein, the term “Group III oil base stock,” and grammatical variations thereof, refer generally to refined crude oils which undergo severe hydro-processing (e.g., hydro-cracking, hydro-isomerization, and/or hydro-treating) to achieve the same refinement standards as Group II, while having a VI greater than 120. As used herein, the term “Group IV oil base stock,” and grammatical variations thereof, refer generally to synthetic poly-α-olefins (PAOs) (e.g., produced by oligomerization of α-olefins, such as 1-decene, 1-butene, and propene), comprising conventional PAOs and metallocene PAOs (e.g., produced using a metallocene catalyst), typically with a VI of 125-300. As used herein, the term “Group V oil base stock,” and grammatical variations thereof, refer generally to include all base stocks that do not belong to Groups I-IV, such as alkylated naphthalenes, alkylated benzenes, polyalkylene glycols (PAG), and esters.

Further designations commonly used by oil producers, but not officially recognized by the API, may be used, including Group II+ oil base stocks and Group III+ oil base stocks. As used herein, the term “Group II+ oil base stock,” and grammatical variations thereof, refer generally to Group II oil base stock which are further treated (e.g., hydro-treated) to have a VI of from about 110 to about 120. As used herein, the term “Group III+ oil base stock,” and grammatical variations thereof, refer generally to synthetic oils, e.g., produced by Fischer-Tropsch reactions of hydrogen and carbon monoxide (e.g., CTL oil base stocks, GTL oil base stocks) having a VI of approximately 135-145.

Oil base stocks may be alternatively defined by a viscosity and/or volatility grade classification, which varies from producer to producer. Generally, viscosity grade classifications range, in order of increasing viscosity and mid-point boiling point. As used herein, the terms “kinematic viscosity,” “KV,” and grammatical variations thereof, refer generally to the ratio of the dynamic viscosity to the density of a material at the same temperature and pressure. The gear oil compositions may have a KV measured at a defined temperature as defined by ASTM D445-21 or ASTM D7279 or ASTM D7042. Shorthand terms for kinematic viscosity at commonly used defined temperatures are KV100 (e.g., 100° C.) and KV40 (e.g., 40° C.).

As used herein, the term “light neutral oil base stock,” and grammatical variations thereof, refer generally to an oil base stock having a KV100 of about 4-6 cSt. As used herein, the term “medium neutral oil base stocks,” and grammatical variations thereof, refer generally to oil base stocks having a KV100 of about 7-9 cSt. As used herein, the term “Heavy neutral oil base stocks,” and grammatical variations thereof, refer generally to oil base stocks having a KV100 of about 10-12 cSt. As used herein, the term “extra heavy neutral oil base stock,” and grammatical variations thereof, refer generally to an oil base stock with KV100 of ≥about 30 cSt. As used herein, the term “Group II/II+ extra heavy neutral oil base stock,” and grammatical variations thereof, refer generally to a Group II oil base stock, a Group II+ oil base stock, or any combination thereof, which meets the KV100 requirements of an extra heavy neutral oil base stock.

Oil base stocks may be defined by a cold cranking viscosity (“CCS”) determined using American Society for Testing and Materials Test Method (ASTM) D5893, which is the Standard Test Method for Apparent Viscosity of Engine Oils Between −5 and −35 C Using the Cold Crank Simulator. An oil base stock may also be defined by a Noack volatility, determined using ASTM D5800-10, which is the Standard Test Method for Evaporation Loss of Lubricating Oils by the Noack Method. An oil base stock may be defined as a “Trim Stock,” which refers to an oil base stock that may be blended at a lesser amount with other oil base stocks of a base oil or lubricant to bring a viscosity, CCS value, and/or a Noack volatility of a blended base oil into a desired range. In an embodiment, a Trim Stock is a lighter oil base stock (i.e., having a lower boiling point and/or kinematic viscosity, e.g., KV100) than other oil base stocks of a base oil or lubricant.

All references herein to ASTM, DIN, ISO, or other standards refer to the edition most recently published before the priority date of the present application, unless a different edition is expressly identified.

### Wind Turbine Gear Oil Compositions

In an aspect, the present disclosure provides wind turbine gear oil compositions. In an embodiment, wind turbine gear oil compositions of the present disclosure are prepared by methods of the present disclosure. As used herein, the term “wind turbine gear oil,” and grammatical variations thereof, refer generally to oils that are used for centralized lubrication of various systems in industrial machines, such as bearings and wind turbine gears, where the oil is continuously circulated to the friction points of system components, collected, and recirculated.

Wind turbine gear oil compositions of the present disclosure comprise: a base oil comprising a Group II/II+ extra heavy neutral oil base stock and a Group III/III+ oil base stock and/or a Group V oil base stock, and a performance additive package. Wind turbine gear oil compositions of the present disclosure may have various equivalent or improved performance values, as compared to a typical wind turbine gear oil composition, e.g., where a typical base oil thereof (e.g., a PAO, a CTL, a GTL, or a EAO-based base oil) is replaced with a base oil comprising a Group II/II+ extra heavy neutral oil base stock and a Group III/III+ oil base stock and/or a Group V oil base stock, where the base oils are matched for rheological properties. Equivalent or improved performance may be observed where a portion of or all of the oil base stock of a typical wind turbine gear oil composition is replaced with a Group II/II+ extra heavy neutral oil base stock and a Group III/III+ oil base stock and/or a Group V oil base stock. A wind turbine gear oil composition of the disclosure may display an equivalent or improved fluidity at a lower temperature, oxidation stability, the like, or any combination thereof, as compared to a typical wind turbine gear oil composition. A wind turbine gear oil composition of the disclosure may display from about 5% to about 40% improved performance properties, including all % values and subsets therebetween (e.g., from about 10% to about 30% improved performance), as compared to a typical wind turbine gear oil composition.

In an aspect, wind turbine gear oil compositions of the present disclosure exhibit equivalent or improved performance, as compared to corresponding wind turbine gear oil compositions wherein all of the Group II/II+ extra heavy neutral oil base stock is replaced with a Group IV oil base stock and optionally a Group III/III+ oil base stock and/or a Group V oil base stock. In an embodiment, the Group IV oil base stock is a metallocene polyolefin (mPAO) oil base stock. In an embodiment, the Group III/III+ oil base stock is a gas-to-liquid (GTL) oil base stock. In an embodiment, the Group II/II+ extra heavy neutral oil base stock is replaced with a mixture of a mPAO 150 oil base stock and a GTL 8 oil base stock. In an embodiment, the Group V oil base stock is an alkylated naphthalene compound or an adipate ester.

Wind turbine gear oil compositions of the present disclosure may be specifically formulated for equivalent or improved performance, particularly for improved energy efficiency and/or improved oil life. Unexpectedly, wind turbine gear oil compositions of the present disclosure may achieve equivalent or improved performance (e.g., corrosiveness, demulsibility, pour point, wearing, foaming, oxidation stability, deposits, the like, or any combination thereof) compared to typical wind turbine gear oil compositions, e.g., PAO-based, CTL-based, GTL-based, or EAO-based wind turbine gear oil compositions, or the like.

In an embodiment, wind turbine gear oil compositions of the present disclosure exhibit equivalent or improved low temperature performance, as compared to corresponding wind turbine gear oil compositions wherein at least a portion of or all of the Group II/II+ extra heavy neutral oil base stock is replaced with a Group IV oil base stock and optionally a Group III/III+ oil base stock. In an embodiment, the Group IV oil base stock is a metallocene polyolefin (mPAO) oil base stock. In an embodiment, the Group III/III+ oil base stock is a gas-to-liquid (GTL) oil base stock. In an embodiment, the Group II/II+ extra heavy neutral oil base stock is replaced with a mixture of a mPAO 150 oil base stock and a GTL 8 oil base stock. In an embodiment, said improved low temperature performance is a reduced pour point as measured by ASTM D97.

In some embodiments, in the corresponding wind turbine gear oil compositions, at least 60% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock. For example, at least 60%, at least 65%, at least 70%, at least 75%, at least 80%, at least 85%, at least 90%, at least 95%, or 100% of the Group II/II+ extra heavy neutral oil base stock may be replaced with the Group IV oil base stock and up to 40%, up to 35%, up to 30%, up to 25%, up to 20%, up to 15%, up to 10%, up to 5%, or 0%, respectively, of the Group II/II+ extra heavy neutral oil base stock may be replaced with the Group III/III+ oil base stock and/or the Group V oil base stock.

Wind turbine gear oil compositions of the present disclosure may have various performance values (e.g., viscometrics, corrosiveness, demulsibility, pour point, foaming, wearing, oxidation stability, deposits, or the like). The wind turbine gear oil compositions of the present disclosure may be competitive with or superior to PAO-based, CTL-based, GTL-based, or EAO-based wind turbine gear oil compositions in one or more performance properties.

In an embodiment, wind turbine gear oil compositions of the present disclosure may meet the requirements of a DIN 51517-3 gear oil specification. DIN stands for “Deutsches Institut für Normung e. V.”, which, in English, is the German Institute for Standardisation, which issues standards for nearly every field of technology. The designation of a DIN standard number (“#”) may be shown as DIN # (for German standards), DIN EN # (for the German edition of European standards), DIN ISO # (for the German edition of International Organization for Standardization (“ISO”) standards), or DIN EN ISO # (for German edition of ISO standards also adopted as a European standard).

Wind turbine gear oil compositions may have various kinematic viscosity values. The wind turbine gear oil compositions may have a KV40, as determined by DIN EN ISO 3104. The wind turbine gear oil compositions may may meet the requirements of a DIN 51517-3 gear oil specification and may have a KV40 (DIN EN ISO 3104) of from about 288 centistokes (cSt) to about 352 cSt, including all cSt values and subsets therebetween (e.g., from about 288 cSt to about 350 cSt, from about 288 cSt to about 340 cSt, from about 288 cSt to about 330 cSt, from about 288 cSt to about 320 cSt, from about 288 cSt to about 310 cSt, from about 288 cSt to about 300 cSt, from about 288 cSt to about 290 cSt, from about 290 cSt to about 352 cSt, from about 300 cSt to about 352 cSt, from about 310 cSt to about 352 cSt, from about 320 cSt to about 352 cSt, from about 330 cSt to about 352 cSt, or from about 340 cSt to about 352 cSt, from about 350 cSt to about 352 cSt, from about 290 cSt to about 310 cSt, from about 300 cSt to about 320 cSt, from about 310 cSt to about 330 cSt, from about 320 cSt to about 340 cSt, from about 330 cSt to about 350 cSt, or about 290 cSt, about 300 cSt, about 310 cSt, about 320 cSt, about 330 cSt, about 340 cSt or about 350 cSt). In an embodiment, the wind turbine gear oil composition exhibits one or more of the following: a KV40, as determined by DIN EN ISO 3104, of from about 290 cSt to about 320 cSt. In an alternative embodiment the wind turbine gear oil may be an ISO VG 220 with a KV40 between 198 cSt and 242 cSt, including all cSt values and subsets therebetween. In a further embodiment, the wind turbine gear oil may be an ISO VG 460 with a viscosity between 414 and 506 cSt including all cSt values and subsets therebetween.

In some embodiments, the wind turbine gear oil compositions may have a KV40, as determined by DIN EN ISO 3104, of from about 290 cSt to about 370 cSt, including all cSt values and subsets therebetween (e.g., from about 290 cSt to about 370 cSt, from about 290 cSt to about 340 cSt, from about 290 cSt to about 330 cSt, from about 290 cSt to about 320 cSt, from about 290 cSt to about 310 cSt, from about 290 cSt to about 300 cSt, from about 290 cSt to about 290 cSt, from about 290 cSt to about 352 cSt, from about 300 cSt to about 352 cSt, from about 310 cSt to about 352 cSt, from about 320 cSt to about 352 cSt, from about 330 cSt to about 352 cSt, or from about 340 cSt to about 352 cSt, from about 370 cSt to about 352 cSt, from about 290 cSt to about 310 cSt, from about 300 cSt to about 320 cSt, from about 310 cSt to about 330 cSt, from about 320 cSt to about 340 cSt, from about 330 cSt to about 370 cSt, or about 290 cSt, about 300 cSt, about 310 cSt, about 320 cSt, about 330 cSt, about 340 cSt, about 350 cSt, about 360 cSt, or about 370 cSt).

Wind turbine gear oil compositions may have various viscosity index (“VI”) values. The wind turbine gear oil compositions may have a viscosity index (“VI”) as determined by DIN ISO 2909. The wind turbine gear oil compositions may have a VI (DIN ISO 2909) greater than about 90. In an embodiment, the wind turbine gear oil compositions may have a VI (DIN ISO 2909) of from about 91 to about 180, including all values and subsets therebetween (e.g., from about 91 to about 180, from about 91 to about 170, from about 91 to about 160, from about 91 to about 150, from about 91 to about 140, from about 91 to about 130, from about 91 to about 120, from about 91 to about 110, from about 91 to about 100, from about 100 to about 180, from about 100 to about 170, from about 100 to about 160, from about 100 to about 150, from about 100 to about 140, from about 100 to about 130, from about 100 to about 120, from about 100 to about 110, from about 110 to about 180, from about 110 to about 170, from about 110 to about 160, from about 110 to about 150, from about 110 to about 140, from about 110 to about 130, from about 110 to about 120, from about 120 to about 180, from about 120 to about 170, from about 120 to about 160, from about 120 to about 150, from about 120 to about 140, from about 120 to about 130, from about 130 to about 180, from about 130 to about 170, from about 130 to about 160, from about 130 to about 150, from about 130 to about 140, from about 140 to about 180, from about 140 to about 170, from about 140 to about 160, from about 140 to about 150, from about 150 to about 180, from about 150 to about 170, from about 150 to about 160, from about 160 to about 180, from about 160 to about 170, from about 170 to about 180). In an embodiment, the wind turbine gear oil compositions exhibit a VI, as determined by DIN ISO 2909, of from about 91 to about 160.

In some embodiments, wind turbine gear oil compositions may have a VI (DIN ISO 2909) from about 150 to about 185, including all values and subsets therebetween (e.g., from about 150 to about 185, from about 150 to about 180, from about 150 to about 175, from about 150 to about 170, from about 150 to about 165, from about 150 to about 160, from about 155 to about 185, from about 155 to about 180, from about 155 to about 175, from about 155 to about 170, from about 155 to about 165, from about 160 to about 185, from about 160 to about 180, from about 160 to about 175, from about 160 to about 170, from about 165 to about 185, from about 165 to about 180, from about 165 to about 175, from about 170 to about 185, from about 170 to about 180, or from about 175 to about 185). In an embodiment, the wind turbine gear oil compositions exhibit a VI, as determined by DIN ISO 2909, of from about 91 to about 160.

Wind turbine gear oil compositions may have various density values. The wind turbine gear oil compositions may have a density as determined by DIN 51757. In an embodiment, the wind turbine gear oil compositions have a density (DIN 51757) of from about 0.75 g/mL to about 1.0 g/mL, including all g/mL values and subsets therebetween (e.g., from about 0.75 g/mL to about 0.95 g/mL from about 0.75 g/mL to about 0.9 g/mL, from about 0.75 g/mL to about 0.85 g/mL from about 0.75 g/mL to about 0.8 g/mL, from about 0.8 g/mL to about 1.0 g/mL, from about 0.8 g/mL to about 0.95 g/mL, from about 0.8 g/mL to about 0.9, from about 0.8 g/mL to about 0.85 mL, from about 0.85 g/mL to about 1.0 g/mL, from about 0.85 to about 0.95 g/mL, from about 0.85 g/mL to about 0.8 g/mL, from about 0.9 g/mL to about 1.0 g/mL, from about 0.9 g/mL to about 0.95 g/mL, or from about 0.95 g/mL to about 1.0 g/mL,). In an embodiment, the wind turbine gear oil compositions have a density (DIN 51757) of from about 0.8 g/mL to about 0.85 g/mL.

Wind turbine gear oil compositions may have various flash point values. The wind turbine gear oil compositions may have a flash point as determined by DIN EN ISO 2592. In an embodiment, the wind turbine gear oil compositions have a flash point (DIN EN ISO 2592) greater than about 200° C. In an embodiment, the wind turbine gear oil compositions have a flash point (DIN EN ISO 2592) of from about 250° C. to about 350° C., including all ° C. values and subsets therebetween (e.g., from about 250° C. to about 340° C., from about 250° C. to about 330° C., from about 250° C. to about 320° C., from about 250° C. to about 310° C., from about 250° C. to about 300° C., from about 250° C. to about 290° C., from about 250° C. to about 280° C., from about 250° C. to about 270° C., from about 250° C. to about 260° C., from about 260° C. to about 350° C., from about 260° C. to about 340° C., from about 260° C. to about 330° C., from about 260° C. to about 320° C., from about 260° C. to about 310° C., from about 260° C. to about 300° C., from about 260° C. to about 290° C., from about 260° C. to about 280° C., from about 260° C. to about 270° C., from about 270° C. to about 350° C., from about 270° C. to about 340° C., from about 270° C. to about 330° C., from about 270° C. to about 320° C., from about 270° C. to about 310° C., from about 270° C. to about 300° C., from about 270° C. to about 290° C., from about 270° C. to about 280° C., from about 280° C. to about 350° C., from about 280° C. to about 340° C., from about 280° C. to about 330° C., from about 280° C. to about 320° C., from about 280° C. to about 310° C., from about 280° C. to about 300° C., from about 280° C. to about 290° C., from about 290° C. to about 350° C., from about 290° C. to about 340° C., from about 290° C. to about 330° C., from about 290° C. to about 320° C., from about 290° C. to about 310° C., from about 290° C. to about 300° C., from about 300° C. to about 350° C., from about 300° C. to about 340° C., from about 300° C. to about 330° C., from about 300° C. to about 320° C., from about 300° C. to about 310° C., from about 310° C. to about 350° C., from about 310° C. to about 340° C., from about 310° C. to about 330° C., from about 310° C. to about 320° C., from about 320° C. to about 350° C., from about 320° C. to about 340° C., from about 320° C. to about 330° C., from about 330° C. to about 350° C., from about 330° C. to about 340° C., or from about 340° C. to about 350° C.).

Wind turbine gear oil compositions may have various pour point values. As used herein, the term “pour point,” and grammatical variations thereof, refer generally to the temperature at which an oil becomes semi-solid and loses its flow characteristics. The wind turbine gear oil compositions may have a pour point as determined by DIN ISO 3016. In an embodiment, the wind turbine gear oil compositions have a pour point (DIN ISO 3016) less than about −9° C. In an embodiment, the wind turbine gear oil compositions have a pour point (DIN ISO 3016) of from about −60° C. to about −20° C., including all ° C. values and subsets therebetween (e.g., from about −60° C. to about −20° C., from about −60° C. to about −25° C., from about −60° C. to about −30° C., from about −60° C. to about −35° C., from about −60° C. to about −40° C., from about −60° C. to about −45° C., from about −60° C. to about −50° C., from about −60° C. to about −55° C., from about −55° C. to about −20° C., from about −55° C. to about −25° C., from about −55° C. to about −30° C., from about −55° C. to about −35° C., from about −55° C. to about −40° C., from about −55° C. to about −45° C., from about −55° C. to about −50° C., from about −50° C. to about −40° C., from about −50° C. to about −35° C., from about −50° C. to about −30° C., from about −50° C. to about −25° C., from about −45° C. to about −20° C., from about −45° C. to about −25° C., from about −45° C. to about −30° C., from about −45° C. to about −35° C., from about −45° C. to about −40° C., from about −40° C. to about −20° C., from about −40° C. to about −25° C., from about −40° C. to about −30° C., from about −40° C. to about −35° C., from about −35° C. to about −20° C., from about −35° C. to about −25° C., from about −35° C. to about −30° C., from about −30° C. to about −20° C., or from about −30° C. to about −25° C.). In an embodiment, the wind turbine gear oil compositions exhibit a pour point, as determined by DIN ISO 3016, of from about −60° C. to about −30° C. The wind turbine gear oil compositions of the present disclosure accordingly are competitive with traditional wind turbine gear oil compositions (e.g., PAO-based wind turbine gear oil compositions), even without a pour point depressant.

A tested pour point of a wind turbine gear oil composition of the disclosure may be considered equivalent to the reference pour point of a corresponding wind turbine gear oil composition if the tested pour point is within the 95% confidence interval of reproducibility set forth in DIN ISO 3016.

In an embodiment, wind turbine gear oil compositions may exhibit a pour point, as determined by DIN ISO 3016, of from about −50° C. to about −30° C.

Wind turbine gear oil compositions may have various total acid number (TAN) values. The wind turbine gear oil compositions may have a TAN value as determined by DIN ISO 6618. In an embodiment, the wind turbine gear oil compositions have a TAN (DIN 51757) of from about 0.5 to about 1.0, including all TAN values and subsets therebetween (e.g., from about 0.5 to about 0.9, from about 0.5 to about 0.8, from about 0.5 to about 0.7, from about 0.6 to about 1.0, from about 0.6 to about 0.9, from about 0.6 to about 0.8, from about 0.7 to about 1.0, from about 0.7 to about 0.9, from about 0.8 to about 1.0, from about 0.8 to about 0.9, or from about 0.9 to about 1.0). In an embodiment, the wind turbine gear oil compositions have a TAN (DIN ISO 6618) of from about 0.5 to about 0.8.

Wind turbine gear oil compositions may have various water content (weight % or ppm) values. The wind turbine gear oil compositions may have a water content value as determined by DIN 51777-2. In an embodiment, the wind turbine gear oil compositions have a water content (DIN 51777-2) less than 0.1 wt. %. In an embodiment, the wind turbine gear oil compositions have a water content (DIN 51777-2) of from about 50 ppm to about 150 ppm, including all ppm values and subsets therebetween (e.g., from about 50 ppm to about 140 ppm, from about 50 ppm to about 130 ppm, from about 50 ppm to about 120 ppm, from about 50 ppm to about 110 ppm, from about 50 ppm to about 100 ppm, from about 50 ppm to about 90 ppm, from about 50 ppm to about 80 ppm, from about 50 ppm to about 70 ppm, from about 50 ppm to about 60 ppm). In an embodiment, the wind turbine gear oil compositions have a water content (DIN 51777-2) of from about 0.5 to about 0.8.

Wind turbine gear oil compositions may have various foaming values (i.e., after air is churned into the composition using a high-speed gearbox). Foaming tendency (i.e., total percentage (%) volume increase (i.e., due to entrained air and foam) at 1 minute (min) post-churning, or the % volume increase of the oil in air dispersion at 5 min post-churning) may be determined by ISO 12152. The wind turbine gear oil compositions may have a total volume increase (ISO 12152) of less than about 15%. The wind turbine gear oil compositions may have a total volume increase (ISO 12152) of from about 5% to about 14%, including all % values and subsets therebetween (e.g., from about 5% to about 13%, from about 5% to about 12%, from about 5% to about 11%, from about 5% to about 10%, from about 5% to about 9%, from about 5% to about 8%, from about 5% to about 7%, from about 5% to about 6%, from about 6% to about 14%, from about 6% to about 13%, from about 6% to about 12%, from about 6% to about 11%, from about 6% to about 10%, from about 6% to about 9%, from about 6% to about 8%, from about 6% to about 7%, from about 7% to about 14%, from about 7% to about 13%, from about 7% to about 12%, from about 7% to about 11%, from about 7% to about 10%, from about 7% to about 9%, from about 7% to about 8%, from about 8% to about 14%, from about 8% to about 13%, from about 8% to about 12%, from about 8% to about 11%, from about 8% to about 10%, from about 8% to about 9%, from about 9% to about 14%, from about 9% to about 13%, from about 9% to about 12%, from about 9% to about 11%, from about 9% to about 10%, from about 10% to about 14%, from about 10% to about 13%, from about 10% to about 12%, from about 10% to about 11%, from about 11% to about 14%, from about 11% to about 13%, from about 11% to about 12%, from about 12% to about 14%, from about 12% to about 13%, or from about 13% to about 14%). The wind turbine gear oil compositions may have a total volume increase (ISO 12152) of from about 8% to about 12%.

A foaming tendency determined by ISO 12152 of a wind turbine gear oil composition of the disclosure may be considered equivalent to the reference foaming tendency of a corresponding wind turbine gear oil composition if the tested foaming tendency is within the 95% confidence interval of reproducibility set forth in ISO 12152.

The wind turbine gear oil compositions may have an oil in air dispersion volume increase (ISO 12152) less than about 10%. The wind turbine gear oil compositions may have an oil in air dispersion volume increase (ISO 12152) of from about 1% to about 9%, including all % values and subsets therebetween (e.g., from about 1% to about 8%, from about 1% to about 7%, from about 1% to about 6%, from about 1% to about 5%, from about 1% to about 4%, from about 1% to about 3%, from about 1% to about 2%, from about 2% to about 9%, from about 2% to about 8%, from about 2% to about 7%, from about 2% to about 6%, from about 2% to about 5%, from about 2% to about 4%, from about 2% to about 3%, from about 3% to about 9%, from about 3% to about 8%, from about 3% to about 7%, from about 3% to about 6%, from about 3% to about 5%, from about 3% to about 4%, from about 4% to about 9%, from about 4% to about 8%, from about 4% to about 7%, from about 4% to about 6%, from about 4% to about 5%, from about 5% to about 9%, from about 5% to about 8%, from about 5% to about 7%, from about 5% to about 6%, from about 6% to about 9%, from about 7% to about 9%, from about 7% to about 8%, or from about 8% to about 9%). The wind turbine gear oil compositions may have an oil in air dispersion volume increase (ISO 12152) of about 4% to about 8%.

Wind turbine gear oil compositions may have various demulsibility values. As used herein, the term “demulsibility,” and grammatical variations thereof, refer generally to the ability of a lubricant to separate from water and prevent the formation of emulsions of water and a lubricant. The wind turbine gear oil compositions may have demulsibility values as determined by DIN ISO 6614. The wind turbine gear oil compositions may have a demulsibility time, minutes (min), (time to full separation of oil and water), as determined by DIN ISO 6614 (@82° C.). The wind turbine gear oil compositions may have a demulsibility time (DIN ISO 6614 (@82° C.)) less than about 30 min. The wind turbine gear oil compositions may have a demulsibility time (DIN ISO 6614 (@82° C.)) of from about 5 min to about 25 min, including all min values and subsets therebetween (e.g., from about 5 min to about 20 min, from about 5 min to about 15 min, from about 5 min to about 10 min, from about 10 minutes to about 20 minutes, from about 10 min to about 15 min, from about 15 min to about 20 min). The wind turbine gear oil compositions may have a demulsibility time (DIN ISO 6614 (@82° C.)) of from about 10 min to about 20 min.

A tested demulsibility time determined by DIN ISO 6614 of a wind turbine gear oil composition of the disclosure may be considered equivalent to the reference demulsibility time of a corresponding wind turbine gear oil composition if the tested demulsibility time is within the 95% confidence interval of reproducibility set forth in DIN ISO 6614.

Wind turbine gear oil compositions may have various corrosiveness values. The wind turbine gear oil compositions may have corrosiveness values as determined by DIN EN ISO 2160 (e.g., copper corrosion), and DIN ISO 7120 (e.g., rust formation). The wind turbine gear oil compositions may have a corrosiveness to copper rating of 1B, as determined by DIN EN ISO 2160 (@ 212° F. (100° C.), 3 hours (hrs)), and/or may have a PASSING visual rating for rust formation in DI water, as determined by DIN ISO 7120 (@140° F. (60° C.), 24 hrs).

Wind turbine gear oil compositions may have various oxidation stability values. As used herein, the term “oxidation stability,” and grammatical variations thereof, refer generally to the resistance of an oil to react with oxygen, which can cause degradation and contribute to varnish, deposits, and poor machine performance. The wind turbine gear oil compositions may have oxidation stability values as determined by DIN EN ISO 4263-4. The wind turbine gear oil compositions may have a KV100 increase, percentage (%), as determined by DIN EN ISO 4263-4 (@121° C.). The wind turbine gear oil compositions may have a KV100 increase (DIN EN ISO 4263-4 (@121° C.)) of less than about 6%. The wind turbine gear oil compositions may have a KV100 increase (DIN EN ISO 4263-4 (@121° C.)) of about 5% or less, including all % values and subsets therebetween (e.g., about 4.9% or less, about 4.5% or less, about 4% or less, about 3.5% or less, about 3% or less, about 2.5% or less, about 2% or less, about 1.5% or less, about 1.0% or less, about 0.75% or less, about 0.5% or less, about 0.25% or less, or about 0.1% or less). The wind turbine gear oil compositions may have a KV100 increase (DIN EN ISO 4263-4 (@121° C.)) of about 2%. The wind turbine gear oil compositions may have a precipitation number, (insolubles content) as determined by DIN EN ISO 4263-4 (@121° C.). The wind turbine gear oil compositions may have a precipitation number (DIN EN ISO 4263-4 (@121° C.)) less than about 0.1 mL.

A KV100 increase determined by DIN EN ISO 4263-4 of a wind turbine gear oil composition of the disclosure may be considered equivalent to the reference KV100 increase of a corresponding wind turbine gear oil composition if the tested KV100 increase is no more than the 1 percentage point greater than the reference KV100 increase of the corresponding wind turbine gear oil composition.

In an embodiment, the wind turbine gear oil compositions may have a KV100 increase (DIN EN ISO 4263-4 (@121° C.)) of 2% or less.

Wind turbine gear oil compositions may have various wearing properties. The wind turbine gear oil compositions may have wear properties as determined by DIN ISO 14635-1 or DIN 51819-3. The wind turbine gear oil compositions may have a PASSING rating according to a FZG Scuffing Test (no failure after load stage 12) as determined by DIN ISO 14635-1. The wind turbine gear oil compositions may have a FE8 Roller Wear value less than about 30 mg as determined by DIN 51819-3. The wind turbine gear oil compositions may have a FE8 Roller Wear value of from about 0 mg to about 29 mg, including all mg values and subsets therebetween (e.g., from about 0 mg to about 1 mg, from about 0 mg to about 2 mg, from about 0 mg to about 5 mg, from about 0 mg to about 10 mg, from about 0 mg to about 20 mg, from about 0 mg to about 25 mg, from about 0.1 mg to about 1 mg, from about 0.1 mg to about 2 mg, from about 0.1 mg to about 5 mg, from about 0.1 mg to about 10 mg, from about 0.1 mg to about 20 mg, from about 0.1 mg to about 25 mg, from about 0.5 mg to about 1 mg, from about 0.5 mg to about 2 mg, from about 0.5 mg to about 5 mg, from about 0.5 mg to about 10 mg, from about 0.5 mg to about 20 mg, from about 0.5 mg to about 25 mg, from about 1 mg to about 2 mg, from about 1 mg to about 5 mg, from about 1 mg to about 10 mg, from about 1 mg to about 20 mg, from about 1 mg to about 25 mg, from about 5 mg to about 10 mg, from about 5 mg to about 20 mg, from about 5 mg to about 25 mg, from about 10 mg to about 20 mg, from about 10 mg to about 25 mg, or from about 25 mg to about 29 mg). The wind turbine gear oil compositions may have a FE8 Roller Wear value (DIN 51819-3) of from about 0 mg to about 2 mg.

The wind turbine gear oil compositions may have a reported FE8 Cage Wear value as determined by DIN 51819-3. The wind turbine gear oil compositions may have a FE8 Cage Wear value less than about 200 mg. The wind turbine gear oil compositions may have a FE8 Cage Wear value of from about 70 mg to about 130 mg, including all mg values and subsets therebetween (e.g., from about 70 mg to about 125 mg, from about 70 mg to about 120 mg, from about 70 mg to about 115 mg, from about 70 mg to about 110 mg, from about 70 mg to about 100 mg, from about 70 mg to about 90 mg, from about 70 mg to about 80 mg, from about 80 mg to about 130 mg, from about 80 mg to about 125 mg, from about 80 mg to about 120 mg, from about 80 mg to about 115 mg, from about 80 mg to about 110 mg, from about 80 mg to about 100 mg, from about 80 mg to about 90 mg, from about 90 mg to about 130 mg, from about 90 mg to about 125 mg, from about 90 mg to about 120 mg, from about 90 mg to about 115 mg, from about 90 mg to about 110 mg, from about 90 mg to about 100 mg, from about 100 mg to about 130 mg, from about 100 mg to about 125 mg, from about 100 mg to about 120 mg, from about 100 mg to about 115 mg, from about 100 mg to about 110 mg, from about 110 mg to about 130 mg, from about 110 mg to about 125 mg, from about 110 mg to about 120 mg, from about 110 mg to about 115 mg, from about 115 mg to about 130 mg, from about 115 mg to about 125 mg, from about 115 mg to about 120 mg, from about 120 mg to about 130 mg, from about 120 mg to about 125 mg, or from about 125 mg to about 130 mg). The wind turbine gear oil compositions may have a FE8 Roller Wear value (DIN 51819-3) of from about 100 mg to about 120 mg.

In an embodiment, wind turbine gear oil compositions of the present disclosure comprise: a base oil comprising a Group II/II+ extra heavy neutral oil base stock, and a performance additive package; wherein the wind turbine gear oil composition exhibits one or more of the following, as compared to a corresponding wind turbine gear oil composition wherein all of the Group II/II+ extra heavy neutral oil base stock is replaced with a Group IV oil base stock and optionally a Group III/III+ oil base stock and/or a Group V oil base stock: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or decreased wearing, determined by DIN ISO 14635-1 or DIN 51819-3; and equivalent or reduced oxidation, as determined by DIN EN ISO 4263-4, as compared to a corresponding wind turbine gear oil composition comprising, as the first oil base stock: a polyalphaolefin (PAO) oil base stock, a metallocene polyalphaolefin (PAO) oil base stock, a coal-to-liquid (CTL) oil base stock, a gas-to-liquid (GTL) oil base stock, an ethylene-α-olefin copolymer (EAO) oil base stock, or any combination thereof.

Relative to any corresponding wind turbine gear oil composition wherein all of the Group II/II+ extra heavy neutral oil base stock is replaced with a Group IV oil base stock and, optionally, a Group III/III+ oil base stock and/or a Group V oil base stock (e.g., wherein at least 60% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock), wind turbine gear oil compositions of the present disclosure may exhibit any one, any two, any three, any four, any five, or all six of equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

In an embodiment, wind turbine gear oil compositions exhibit one or more of the following: a kinematic viscosity at 40° C. (KV40), as determined by DIN EN ISO 3104, of from 290 cSt to 320 cSt; a viscosity index (VI), as determined by DIN ISO 2909, of from 91 to 150; and a pour point, as determined by DIN ISO 3016, of from −60° C. to −30° C. In an embodiment, wind turbine gear oil compositions exhibit one or more of the following: a demulsibility at 82° C., as determined by DIN ISO 6614, of 10 minutes (min) to 20 min; and a kinematic viscosity at 100° C. (KV100) percent (%) increase at 121° C., as determined by DIN EN ISO 4263-4, of 2% or less.

In an embodiment, wind turbine gear oil compositions exhibit a property selected from the group consisting of a kinematic viscosity at 40° C. (KV40), as determined by DIN EN ISO 3104, of from 290 cSt to 370 cSt; a viscosity index (VI), as determined by DIN ISO 2909, of from 150 to 185; a pour point, as determined by DIN ISO 3016, of from −50° C. to −30° C.; and any combination thereof.

In an embodiment, wind turbine gear oil compositions exhibit a property selected from the group consisting of: a demulsibility at 82° C., as determined by DIN ISO 6614, of 10 minutes (min) to 20 min; a kinematic viscosity at 100° C. (KV100) percent (%) increase at 121° C., as determined by DIN EN ISO 4263-4, of 2% or less; and any combination thereof.

### Group II/II+ Extra Heavy Neutral Oil Base Stocks

As used herein, Group II/II+ extra heavy neutral oil base stocks may be produced through catalytic processing or through hydrotreatment (sour conditions) followed by catalytic dewaxing (sweet conditions) of de-asphalted Group II oil base stocks and/or Group II+ oil base stocks. Wind turbine gear oil compositions of the present disclosure, due to the use of extra heavy Group II/II+ oil base stocks, may allow for increased performance similar to or exceeding performance standards of wind turbine gear oils formulated with solely Group IV oil base stocks (e.g., PAOs) while having lower cost. A suitable example of a commercially available Group II/II+ extra heavy neutral oil base stock includes, but is not limited to, EHC 340 MAX™ (ExxonMobil Corporation).

Group II/II+ extra heavy neutral oil base stocks may have various rheological properties. Group II/II+ extra heavy neutral oil base stocks may have various kinematic viscosity values. Suitable Group II/II+ extra heavy neutral oil base stocks may have a KV40 of from about 250 cSt to about 600 cSt, including all cSt values and subsets therebetween (e.g., from about 250 cSt to about 300 cSt, from about 250 cSt to about 450 cSt, from about 300 cSt to about 450 cSt, from about 300 cSt to about 600 cSt, or from about 450 cSt to about 600 cSt). Suitable Group II/II+ extra heavy neutral oil base stocks may have a KV100 of from about 15 cSt to about 70 cSt, including all cSt values and subsets therebetween (e.g., from about 15 cSt to about 25 cSt, from about 15 cSt to about 50 cSt, from about 25 cSt to about 50 cSt, from about 25 cSt to about 70 cSt, from about 50 cSt to about 70 cSt).

Group II/II+ extra heavy neutral oil base stocks of the present disclosure may have various VI values. Suitable Group II/II+ extra heavy neutral oil base stocks may have a viscosity index (ASTM D2270) of from about 80 to about 120, including all values and subsets therebetween (e.g., from about 90 to about 100, from about 90 to about 110, from about 90 to about 115, from about 95 to about 105, from about 95 to about 115, from about 100 to about 110, or from about 100 to about 120).

Group II/II+ extra heavy neutral oil base stocks of the present disclosure may have various pour point values. Suitable Group II/II+ extra heavy neutral oil base stocks may have a pour point (IP 15 or ASTM D97 or ASTM D7345) of from about −50° C. to about −10° C., including all ° C. values and subsets therebetween (e.g., from about −45° C. to about −20° C., from about −45° C. to about −25° C., from about −45° C. to about −30° C., from about −45° C. to about −35° C., from about −40° C. to about −25° C., from about −40° C. to about −30° C., from about −35° C. to about −20° C., from about −35° C. to about −25° C., or from about −30° C. to about −20° C.). In an embodiment, Group II/II+ extra heavy neutral oil base stocks may have lower pour points, as compared to typical oil base stocks having the same viscosity (e.g., KV40 or KV100) values, including but not limited to PAO oil base stocks, GTL oil base stocks, EAO oil base stocks, and the like.

Group II/II+ extra heavy neutral oil base stocks of the present disclosure may have various oxidation stability values. In an embodiment, Group II/II+ extra heavy neutral oil base stocks may have a KV100% increase (ExxonMobil B10 oxidation test) of about 10% or less, including all % values and subsets therebetween (e.g., about 10%, about 9.9% or less, about 9.8% or less, about 9.5% or less, about 8% or less, about 7% or less, about 6% or less, about 5% or less, about 4% or less, about 3% or less, about 2% or less, or about 1% or less, or from about 1% to about 9.9%).

In an embodiment, Group II/II+ extra heavy neutral oil base stocks of the present disclosure have: a kinematic viscosity at 40° C. (KV40), as determined by ASTM D445, of from about 250 cSt to about 600 cSt; a kinematic viscosity at 100° C. (KV100), as determined by ASTM D445, of from about 15 cSt to about 70 cSt; a viscosity index (VI), as determined by ASTM D2270, of from about 80 to about 120; and/or a pour point, as determined by ASTM D97, of from about −50° C. to about −10° C.

Group II/II+ extra heavy neutral oil base stocks may be included in a wind turbine gear oil composition at from about 25 wt. % to about 99 wt. %, including all wt. % values and subsets therebetween, based on the total weight of the wind turbine gear oil composition (e.g., from about 25 wt. % to about 95 wt. %, from about 30 wt. % to about 99 wt. %, from about 35 wt. % to about 95 wt. %, from about 40 wt. % to about 90 wt. %, from about 45 wt. % to about 85 wt. %, from about 50 wt. % to about 80 wt. %, from about 60 wt. % to about 75 wt. %, from about 70 wt. % to about 90 wt. %, from about 80 wt. % to about 95 wt. %, or from about 95 wt. % to about 99 wt. %).

In some embodiments, Group II/II+ extra heavy neutral oil base stock may be included in the wind turbine gear oil composition at from about 5 wt % to about 98 wt %, including all values and subsets therebetween, based on the total weight of the wind turbine gear oil composition (e.g., from about 5 wt. % to about 95 wt. %, from about 10 wt. % to about 95 wt. %, from about 15 wt. % to about 90 wt. %, from about 20 wt. % to about 85 wt. %, from about 25 wt. % to about 80 wt. %, from about 30 wt. % to about 75 wt. %, from about 40 wt. % to about 70 wt. %, from about 50 wt. % to about 85 wt. %, or from about 70 wt. % to about 98 wt. %). In an embodiment, the Group II/II+ extra heavy neutral oil base stock may be included in the wind turbine gear oil composition at from about 5 wt % to about 98 wt %.

### Group III/III+ Oil Base Stocks

Group III/III+ oil base stocks may include, but are not limited to, CTL oil base stocks, GTL oil base stocks, the like, and any combination thereof. An example of a suitable commercially available Group III/III+ oil base stock includes, but is not limited to, the ALTUM™ series (ExxonMobil, USA) (e.g., ALTUM™ 4 and ALTUM™ 6), the Qatar GTL QHVI™ series (Qatar Shell GTL Limited) (e.g., Qatar GTL QHVI™ 4 (e.g., GTL 4), Qatar GTL QHVI™ 8 (e.g., GTL 8), and the like).

In an embodiment, Group III/III+ oil base stocks are present at from about 15 wt. % to about 50 wt. %, including all wt. % values and subsets therebetween, based on the total weight of the wind turbine gear oil composition (e.g., from about 5 wt. % to about 10 wt. %, from about 5 wt. % to about 20 wt. %, from about 5 wt. % to about 30 wt. %, from about 10 wt. % to about 20 wt. %, from about 10 wt. % to about 30 wt. %, from about 10 wt. % to about 40 wt. %, from about 15 wt. % to about 20 wt. %, from about 15 wt. % to about 30 wt. %, from about 15 wt. % to about 40 wt. %, from about 20 wt. % to about 30 wt. %, from about 20 wt. % to about 40 wt. %, from about 30 wt. % to about 40 wt. %, or from about 20 wt. % to about 25 wt. %). In an embodiment, Group III/III+ oil base stocks are present at from about 15 wt. % to about 30 wt. %, based on the total weight of the wind turbine gear oil composition.

In some embodiments, Group III/III+ oil base stocks are present at from about 10 wt. % to about 40 wt. %, including all values and subsets therebetween, based on the total weight of the wind turbine gear oil composition (e.g., from about 10 wt. % to about 15 wt. %, from about 10 wt. % to about 20 wt. %, from about 10 wt. % to about 30 wt. %, from about 10 wt. % to about 40 wt. %, from about 15 wt. % to about 20 wt. %, from about 15 wt. % to about 30 wt. %, from about 15 wt. % to about 40 wt. %, from about 20 wt. % to about 25 wt. %, from about 20 wt. % to about 30 wt. %, from about 20 wt. % to about 40 wt. %, from about 25 wt. % to about 30 wt. %, from about 25 wt. % to about 40 wt. %, or from about 30 wt. % to about 40 wt. %). In an embodiment, Group III/III+ oil base stocks are present at from about 10 wt. % to about 40 wt. %, based on the total weight of the wind turbine gear oil composition.

### Group V Oil Base Stocks

Group V second oil base stocks may include, but are not limited to, an ester (including esters of a dibasic acid (e.g., phthalic, succinic, alkylsuccinic, alkenylsuccinic, maleic, azelaic, suberic, sebacic, fumaric or adipic acid (adipate), or linolic acid dimmer) and alcohol (e.g., butyl, hexyl, 2-ethylhexyl, dodecyl alcohol, ethylene glycol, diethylene glycol monoether or propylene glycol), and esters of a monocarboxylic acid of 5 to 18 carbon atoms and polyol (e.g., neopentyl glycol, trimethylolpropane (TMP), pentaerythritol, dipentaerythritol or tripentaerythritol)); a naphthalene compound (e.g., an alkylated naphthalene compound); other alkylated aromatic compounds; polyalkylene glycols (PAGs), esters thereof, and ethers thereof; phosphate esters, the like, and any combination thereof. In particular embodiments, the Group V second oil base stocks may comprise a TMP ester, an adipate ester, an alkylated naphthalene, a PAG, and any combination thereof. In an embodiment, the Group V second oil base stock is an alkylated naphthalene compound. Examples of suitable commercially available Group V second oil base stocks include, but are not limited to, adipate esters (e.g., ditridecyl adipate, diisodecyl adipate) (e.g., ESTEREX™ series, ExxonMobil Corporation) and alkylated naphthalene (e.g., SYNESSTIC™ series, ExxonMobil Corporation).

In an embodiment, the additional oil base stock comprises a Group V oil base stock. In an embodiment the additional oil base stock comprises a Group V oil base stock comprising at least one oil base stock selected from the group consisting of an ester (e.g., an adipate ester), a naphthalene compound (e.g., an alkylated naphthalene compound), and any combination thereof. In an embodiment, the additional oil base stock comprises a Group V oil base stock which is an alkylated naphthalene compound.

In an embodiment, the Group V oil base stock may comprise at least one oil base stock selected from the group consisting of esters, naphthalene compounds, polyoxyalkylene glycols (PAGs), esters thereof, ethers thereof, phosphates, and any combination thereof. For example, the Group V oil base stock may comprise an alkylated naphthalene, a ditridecyl adipate ester, or a combination thereof.

In an embodiment, the additional oil base stock comprises a Group V oil base stock present at about 10 weight percent (wt. %) or less, including all wt. % values and subsets therebetween, based on the total weight of the wind turbine gear oil composition (e.g., about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, or about 0.5 wt. % or less). In an embodiment, the Group V oil base stock is present in the wind turbine gear oil formulation at from about 10 weight percent (wt. %) to about 20 wt. %, including all wt. % values and subsets therebetween, based on the total weight of the wind turbine gear oil composition.

In an embodiment, Group V oil base stocks are present at from about 15 wt. % to about 50 wt. %, including all wt. % values and subsets therebetween, based on the total weight of the wind turbine gear oil composition (e.g., from about 5 wt. % to about 10 wt. %, from about 5 wt. % to about 20 wt. %, from about 5 wt. % to about 30 wt. %, from about 10 wt. % to about 20 wt. %, from about 10 wt. % to about 30 wt. %, from about 10 wt. % to about 40 wt. %, from about 15 wt. % to about 20 wt. %, from about 15 wt. % to about 30 wt. %, from about 15 wt. % to about 40 wt. %, from about 20 wt. % to about 30 wt. %, from about 20 wt. % to about 40 wt. %, from about 30 wt. % to about 40 wt. %, or from about 20 wt. % to about 25 wt. %). In an embodiment, Group V oil base stocks are present at from about 15 wt. % to about 30 wt. %, based on the total weight of the wind turbine gear oil composition.

In an embodiment, Group V oil base stocks may be present at from about 1 wt. % to about 10 wt. %, including all values and subsets therebetween, based on the total weight of the wind turbine gear oil composition (e.g., from about 1 wt. % to about 2 wt. %, from about 1 wt. % to about 3 wt. %, from about 1 wt. % to about 5 wt. %, from about 1 wt. % to about 7 wt. %, from about 1 wt. % to about 10 wt. %, from about 2 wt. % to about 5 wt. %, from about 2 wt. % to about 7 wt. %, from about 2 wt. % to about 10 wt. %, from about 3 wt. % to about 5 wt. %, from about 3 wt. % to about 7 wt. %, from about 3 wt. % to about 10 wt. %, from about 5 wt. % to about 7 wt. %, or from about 5 wt. % to about 10 wt. %). In an embodiment, Group V oil base stocks are present at from about 1 wt. % to about 10 wt. %, based on the total weight of the wind turbine gear oil composition.

### Additional Oil Base Stocks

In addition to the Group III/III+ oil base stocks and/or Group V oil base stocks, additional oil base stocks may comprise various types and amounts of base oil stocks. When present, such base oil stocks may be included in a wind turbine gear oil composition at about 75 wt. % or less, including all wt. % values and subsets therebetween, based on the total weight of the wind turbine gear oil composition (e.g., about 75 wt. %, about 70 wt. % or less, about 60 wt. % or less, about 50 wt. % or less, about 40 wt. % or less, about 30 wt. % or less, about 20 wt. % or less, or about 10 wt. % or less).

The additional oil base stock may comprise one single additional base oil stock or two or more different base oil stocks. Additional oil base stocks for use in the wind turbine gear oils may comprise fluids selected from API designated Group I oil base stocks, Group II/II+ oil base stocks (i.e., Group II oil base stocks, Group II+ oil base stocks, or any combination thereof), Group IV oil base stocks, or the like, or any combination thereof. Additional oil base stocks may include, but are not limited to, unrefined or refined crude oils, terpenes, mineral oils, synthetic hydrocarbons, alkylated naphthalenes, alkylated benzenes, naphthenics, esters, the like, or any combination thereof.

Group I oil base stocks may comprise CORE™ series (ExxonMobil Corporation) (e.g., CORE™ 100, CORE™ 150, CORE™ 600, and CORE™ 2500). Group II/II+ oil base stocks may comprise viscosity grade classifications of light neutral, medium neutral, or heavy neutral. Examples of suitable commercially available light neutral and medium neutral Group II/II+ oil base stocks include, but are not limited to, the EHC™ series (ExxonMobil Corporation) (e.g., EHC™ 45, EHC™ 50, EHC™ 65, and EHC™ 110), Ultra-S® 2 (60 Neutral) (S-Oil Corporation), and the like.

Group IV oil base stocks may include various PAOs. PAOs may include, for example, light or heavy conventional PAOs (i.e., light PAOs have lower boiling points than heavy PAOs), metallocene PAOs (mPAOs), the like, and any combination thereof. PAOs are often referred to by their KV100 values (e.g., PAO 40 has a KV100 value of about 40 cSt, PAO 100 has a KV100 value of about 100 cSt). Examples of suitable commercially available typical PAO oil base stocks include, but are not limited to, the SPECTRASYN™ series PAOs (ExxonMobil Corporation) (e.g., SPECTRASYN™ 2, SPECTRASYN™ 2C, SPECTRASYN™ 4, SPECTRASYN™ 5, SPECTRASYN™ 6 (e.g., PAO 6), SPECTRASYN™ 8, SPECTRASYN™ 10, SPECTRASYN™ 40 (e.g., PAO 40), and SPECTRASYN™ 100 (e.g., PAO 100)). Examples of a suitable commercially available metallocene PAOs (mPAOs) include, but are not limited to, the SPECTRASYN ELITE™ series mPAOs (ExxonMobil Chemical) (e.g., SPECTRASYN ELITE™ 65, SPECTRASYN ELITE™ 150, and SPECTRASYN ELITE™ 300), the DURASYN® series (e.g., DURASYN® 180R (e.g., mPAO 100)).

As described above, the base oil stock may additionally function as a Trim Stock. Examples of suitable Trim Stocks may include any low viscosity (“LS”) Group II-IV oil base stocks including, but not limited to, a light neutral or medium neutral Group II/II+ oil base stock, a low viscosity PAO (e.g., PAO 6, PAO 4) oil base stock, a low viscosity gas-to-liquid (GTL) oil base stock (e.g., GTL 4, GTL 8), and the like, and any combination thereof. Examples of suitable commercially available Trim Stocks for use in the present disclosure include, but are not limited to, EHC™ 50, UULTRA-S® 2 (60 Neutral) (S-Oil Corporation), SPECTRASYN™ 6 or SPECTRASYN™ 4, Qatar GTL QHVI™ 4 (Qatar Shell GTL Limited), or Qatar GTL QHVI™ 8 (Qatar Shell GTL Limited).

In an embodiment, the additional oil base stock further comprises a Group III/III+ oil base stock comprising at least one GTL oil base stock. In an embodiment, the additional oil base stock further comprises a Group III/III+ oil base stock which is GTL 8. In an embodiment, an additional oil base stock further comprises a Group III/III+ oil base stock present at about 30 weight percent (wt. %) or less, including all wt. % values and subsets therebetween, based on the total weight of the wind turbine gear oil composition (e.g., about 29 wt. % or less, about 25 wt. % or less, about 20 wt. % or less, about 15 wt. % or less, about 10 wt. % or less, about 5 wt. % or less, about 1 wt. % or less, or about 0.5 wt. % or less). In an embodiment, the Group III/III+ oil base stock is present at about 10 wt. % or less.

In an embodiment, the additional oil base stock further comprises a Group IV oil base stock comprising at least one oil base stock selected from the group consisting of polyalphaolefin (PAO) oil base stocks, metallocene PAO oil base stocks, and any combination thereof. In an embodiment, the additional oil base stock further comprises a Group IV oil base stock comprising a blend of two or more different PAO oil base stocks, such as, but not limited to, a blend of PAO 100 and PAO 40. In an embodiment, the additional oil base stock further comprises a Group IV oil base stock present at about 60 weight percent (wt. %) or less, including all wt. % values and subsets therebetween, based on the total weight of the Group II/II+ extra heavy neutral oil base stock (e.g., about 0.5 wt. % or less, about 1 wt. % or less, about 5 wt. % or less, about 10 wt. % or less, about 20 wt. % or less, about 30 wt. % or less, about 40 wt. % or less, or about 50 wt. % or less). In one embodiment, the Group IV oil base stock is present at about 50 wt. % or less, including all wt. % values and subsets therebetween, based on the total weight of the Group II/II+ extra heavy neutral oil base stock.

When included in wind turbine gear oil compositions, Group IV oil base stocks may be present in the wind turbine gear oil compositions at from about 30 wt % to about 70 wt %, including all values and subsets therebetween, based on the total weight of the wind turbine gear oil composition (e.g., about 30 wt % to about 65 wt. %, about 30 wt % to about 60 wt. %, about 30 wt % to about 55 wt. % or less, about 30 wt % to about 50 wt. % or less, about 30 wt % to about 40 wt. % or less, about 40 wt. % to about 70 wt %, about 50 wt. % to about 70 wt %, or about 60 wt. % to about 70 wt %). In one embodiment, Group IV oil base stocks may be present in the wind turbine gear oil compositions at from about 30 wt % to about 70 wt %.

Suitable base oils for the additional oil base stocks of the present disclosure may have various rheological properties, as determined by any of the rheological testing methods suitable for Group II/II+ extra heavy neutral oil base stocks of the present disclosure. In an embodiment, a base oil for an additional oil base stock has a KV40 of from about 1 cSt to about 2000 cSt, including all cSt values and subsets therebetween. In an embodiment, a base oil for an additional oil base stock may have a KV100 of from about 0.1 cSt to about 300 cSt, including all cSt values and subsets therebetween. In an embodiment, an additional oil base stock may have a VI of from about 60 to about 300, including all viscosity index values and subsets therebetween.

Suitable base oils for additional oil base stocks of the present disclosure may have various pour points. In an embodiment, a base oil may have a pour point value of from about −80° C. to −20° C., including all ° C. values and subsets therebetween (e.g., from about −60° C. to about −25° C., from about −50° C. to about −30° C., or from about −40° C. to about −35° C.).

Suitable base oils for additional oil base stocks of the present disclosure may have various oxidation stability values, as determined by any one of the oxidation stability tests suitable for Group II/II+ extra heavy neutral oil base stocks of the present disclosure. In an embodiment, base oils for additional oil base stocks may have an ExxonMobil B10 oxidation test KV100% increase of about 10% or less, including all % values and subsets therebetween (e.g., about 10%, about 9.9% or less, about 9.8% or less, about 9.5% or less, about 8% or less, about 7% or less, about 6% or less, about 5% or less, about 4% or less, about 3% or less, about 2% or less, or about 1% or less, or from about 1% to about 9.9%).

### Additives for Wind Turbine Gear Oil Compositions

Wind turbine gear oil compositions of the present disclosure may comprise one or more additives (e.g., additives related to solubility, friction, corrosion, oxidation stability, cleanliness, defoaming, viscosity, wearing, low temperature fluidity, the like, and any combination thereof, to satisfy diversified characteristics). In an embodiment, wind turbine gear oil compositions comprise a performance additive package comprising two or more different additives. In an embodiment, wind turbine gear oil compositions comprise from about 0.05 wt. % to about 15 wt. %, including all wt. % values and subsets therebetween, of a performance additive package (e.g., from about 0.1 wt. % to about 15 wt. %, from about 0.5 wt. % to about 10 wt. %, from about 1 wt. % to about 5 wt. %, from about 1.5 wt. % to about 3 wt. %, from about 1 wt. % to about 2 wt. %,), based on the total weight of the wind turbine gear oil composition. In an embodiment, wind turbine gear oil compositions comprise from about 1 wt. % to about 5 wt. % or about 1.5 wt. % to about 3 wt. % of a performance additive package, based on the total weight of the wind turbine gear oil composition. In an embodiment, a wind turbine gear oil composition comprises from about 95 wt. % to about 99 wt. %, including all wt. % values and subsets therebetween, of a base oil, and/or from about 1 wt. % to about 5 wt. %, including all wt. % values and subsets therebetween, of a performance additive package, based on the total weight of the gear oil composition.

Additives for use in the wind turbine gear oil compositions may comprise an antioxidant, an antiwear agent, an antifoaming agent, a demulsifier, a friction modifier, a corrosion inhibitor (e.g., a copper corrosion inhibitor, a rust inhibitor, a metal passivator, or the like), a detergent, a dispersant, a viscosity index improver, a pour point improver, the like, and any combination thereof. The additives for use in the wind turbine gear oil compositions may be metal-containing (e.g., zinc-containing), metal-free (e.g., zinc-free), or ash-free. In an embodiment, the additives are metal-free and ash-free.

Suitable antioxidants may include, but are not limited to, amine-based antioxidants (e.g., alkylated diphenylamine, phenyl-α-naphthylamine and alkylated phenyl-x-naphthylamine); phenol-based antioxidants (e.g., 4,4′-methylenebis-(2,6-di-t-butylphenol), 2,6-di-t-butyl phenol, and isooctyl-3-(3,5-di-t-butyl-4-hydroxyphenyl) propionate); sulfur-based antioxidants (e.g., dilauryl-3,3′-thiodipropionate); zinc dithiophosphate, the like, and any combination thereof.

Suitable antiwear agents may include, but are not limited to, sulfur-based compounds, such as sulfurized fats and oils, organosulfur compounds like thiocarbamates and thiophosphates and inorganic sulphides and phosphorus-based compounds, such as acid phosphates, alkyl phosphates, aryl phosphates thiophosphates, and metal dithiophosphates

Suitable antifoaming agents may include, but are not limited to, dimethyl polysiloxane, polyacrylate and a fluorine derivative thereof, perfluoropolyether, the like, and any combination thereof.

Suitable demulsifiers may include, but are not limited to, sulfonates, esters, polyglycols, ethers and di-epoxides. Some of these are available under the trade names “Pluronic” and “Baserol” by BASF corporation.

Suitable friction modifiers may include, but are not limited to, an organomolybdenum-based compound, fatty acid, higher alcohol, fatty acid ester, oil/fat, amine, polyamide, sulfide ester, phosphoric acid ester, amine salt of phosphoric acid ester, the like, and any combination thereof.

Suitable corrosion inhibitors may include a copper corrosion inhibitor, a rust inhibitor, the like, and any combination thereof. The corrosion inhibitor may include, but is not limited to, a fatty acid, alkenylsuccinic acid half ester, fatty acid soap, alkylsulfonate, polyhydric alcohol/fatty acid ester, fatty acid amine, oxidized paraffin, and alkylpolyoxyethylene ether, the like, and any combination thereof. The corrosion inhibitor may include a metal passivator. Suitable metal passivators may include but are not limited to oil soluble derivatives of benzotriazoles, tolytriazoles and dithiadiazoles.

Suitable detergents may include, but are not limited to, neutral sulfonates, salicylates and carboxylates.

Suitable dispersants may include, but are not limited to, an ashless dispersant. Ashless dispersants may include, but are not limited to, those based on polybutenyl succinic acid imide, polybutenyl succinic acid amide, benzylamine, succinic acid ester, succinic acid ester-amide and a boron derivative thereof, the like, and any combination thereof.

Suitable viscosity index improvers may include, but are not limited to, polyisobutylene (PIB), polymethacrylate (PMA) (e.g., polyalkylmethacrylates), olefin copolymers (OCP) (e.g., ethylene-propylene copolymers, ethylene-propylene diene-modified copolymers (EPDMs), and the like), styrene maleic anhydride ester copolymers (Styrene Esters), hydrogenated styrene diene (HSD) copolymers (e.g., styrene-ethylene/butylene-styrene copolymer (SEBS), styrene-isoprene, and the like), radial isoprene polymers/copolymers, the like, and any combination thereof. An example of a suitable commercially available viscosity index improver includes, but is not limited to, Viscoplex® 8-219 (Evonik). A wind turbine gear oil composition may comprise a viscosity index improver as part of an additive performance package or in addition to an additive performance package (e.g., an additional oil base stock may comprise the viscosity index improver).

Suitable pour point improvers may include a pour point depressant. Pour point depressants may include, but are not limited to, ethylene/vinyl acetate copolymer, condensate of chlorinated paraffin and naphthalene, condensate of chlorinated paraffin and phenol, polymethacrylate, polyalkyl styrene, the like, and any combination thereof. An example of a suitable commercially available viscosity index improver includes, but is not limited to, Viscoplex® 1-333 (Evonik).

### Wind Turbine Gear Oil Methods

In an aspect, the present disclosure provides wind turbine gear oil methods. In an embodiment, the present disclosure provides methods of making wind turbine gear oil compositions. Methods of making a wind turbine gear oil composition of the present disclosure may comprise providing a base oil for the wind turbine gear oil composition. In an embodiment, methods of making a wind turbine gear oil composition further comprise providing a performance additive package of the present disclosure. In an embodiment, methods of making a wind turbine gear oil composition further comprise blending the base oil and the performance additive package, thereby forming the wind turbine gear oil composition.

In certain embodiments, wind turbine gear oil compositions of the present disclosure are formed by mixing the various components of the various base oil stocks and the additives according to one or more methods of the present disclosure. In certain embodiments, the mixture may be heated, such as in a reaction vessel. In certain embodiments, the mixture may be homogenized to ensure well-mixed and evenly dispersed components. If heated, the mixture is cooled after homogenization.

Further, in one or more embodiments, at least the Group II/II+ extra heavy neutral oil base stock and, if present, the additional oil base stock are pre-blended. Moreover, two or more pre-blends may be themselves blended to achieve a lower viscosity index and a lower kinematic viscosity (@40° C. and @100° C.) base oil compared to either of the pre-blends alone. It is to be noted that, alternatively, at least the Group II/II+ extra heavy neutral oil base stock and, if present, the additional oil base stock may be pre-blended without blending with additional pre-blends.

To facilitate a better understanding of the embodiments of the present disclosure, the following examples of representative embodiments are given. In no way should the following examples be read to limit, or to define, the scope of the disclosure.

### Example Embodiments

The present disclosure is further directed to the following non-limiting embodiments.

Embodiment 1. A wind turbine gear oil composition, comprising: a base oil comprising a Group II/II+ extra heavy neutral oil base stock and a Group III/III+ oil base stock and/or a Group V oil base stock, and a performance additive package; wherein the wind turbine gear oil composition exhibits one or more of the following, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or decreased wearing, determined by DIN ISO 14635-1 or DIN 51819-3; and equivalent or reduced oxidation, as determined by DIN EN ISO 4263-4.

Embodiment 2. A wind turbine gear oil composition, comprising: a base oil comprising a Group II/II+ extra heavy neutral oil base stock and an additional oil base stock selected from a Group III/III+ oil base stock and/or a Group V oil base stock, and a performance additive package; wherein the wind turbine gear oil composition exhibits, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

Embodiment 3. The wind turbine gear oil composition of Embodiment 1 or Embodiment 2, wherein the Group II/II+ extra heavy neutral oil base stock has: a kinematic viscosity at 40° C. (KV40), as determined by ASTM D445, of from 250 cSt to 600 cSt; a kinematic viscosity at 100° C. (KV100), as determined by ASTM D445, of from 15 cSt to 70 cSt; a viscosity index (VI), as determined by ASTM D2270, of from 80 to 120; and/or a pour point, as determined by ASTM D97, of from −50° C. to −10° C.

Embodiment 4. The wind turbine gear oil composition of any one of Embodiments 1-3, wherein the additional oil base stock comprises a Group III/III+ oil base stock comprising at least one oil base stock selected from the group consisting of coal-to-liquid (CTL) oil base stocks, gas-to-liquid (GTL) oil base stocks, and any combination thereof.

Embodiment 5. The wind turbine gear oil composition of any one of Embodiments 1-4, wherein the Group III/III+ oil base stock is present at 30 weight percent (wt. %) or less, based on the total weight of the wind turbine gear oil composition.

Embodiment 6. The wind turbine gear oil composition of any one of Embodiments 1-5, wherein the Group V oil base stock comprising at least one oil base stock selected from the group consisting of esters, naphthalene compounds, polyoxyalkylene glycols (PAGs), esters thereof, ethers thereof, phosphates, and any combination thereof.

Embodiment 7. The wind turbine gear oil composition of any one of Embodiments 1-6, wherein the Group V oil base stock is present at from 10 wt. % or less, based on the total weight of the wind turbine gear oil composition.

Embodiment 8. The wind turbine gear oil composition of any one of Embodiments 1-7, wherein the performance additive package comprises at least one additive selected from the group consisting of antioxidants, antiwear agents, antifoam agents, demulsifiers, antirust agents, metal passivators, pour point depressants, and any combination thereof; and/or wherein the wind turbine gear oil composition comprises from 95 weight percent (wt. %) to 99 wt. %, of the base oil, and/or from 1 wt. % to 5 wt. %, of the performance additive package, based on the total weight of the wind turbine gear oil composition.

Embodiment 9. The wind turbine gear oil composition of any one of Embodiments 1-8, wherein the base oil further comprises at least one additional oil base stock selected from a group consisting of Group II oil base stocks, Group II+ oil base stocks, Group IV oil base stocks, and any combination thereof.

Embodiment 10. The wind turbine gear oil composition of any one of Embodiments 1-9, wherein the wind turbine gear oil composition exhibits one or more of the following: a kinematic viscosity at 40° C. (KV40), as determined by DIN EN ISO 3104, of from 290 cSt to 320 cSt; a viscosity index (VI), as determined by DIN ISO 2909, of from 91 to 150; and a pour point, as determined by ASTM D97, of from −60° C. to −30° C.

Embodiment 11. The wind turbine gear oil composition of any one of Embodiments 1-10, wherein the wind turbine gear oil composition exhibits a property selected from the group consisting of: a kinematic viscosity at 40° C. (KV40), as determined by DIN EN ISO 3104, of from 290 cSt to 370 cSt; a pour point, as determined by ASTM D97, of from −50° C. to −30° C.; and any combination thereof.

Embodiment 12. The wind turbine gear oil composition of any one of Embodiments 1-11, wherein the wind turbine gear oil composition exhibits one or more of the following: a demulsibility at 82° C., as determined by DIN ISO 6614, of 10 minutes (min) to 20 min; and a kinematic viscosity at 100° C. (KV100) percent (%) increase at 121° C., as determined by DIN EN ISO 4263-4, of 2% or less.

Embodiment 13. The wind turbine gear oil composition of any one of Embodiments 1-12, wherein the wind turbine gear oil composition exhibits a property selected from the group consisting of: a demulsibility at 82° C., as determined by DIN ISO 6614, of 10 minutes (min) to 20 min; a kinematic viscosity at 100° C. (KV100) percent (%) increase at 121° C., as determined by DIN EN ISO 4263-4, of 2% or less; and any combination thereof.

Embodiment 14. A method for producing a wind turbine gear oil composition, the method comprising: providing a base oil for a wind turbine gear oil composition, the base oil comprising a Group II/II+ extra heavy neutral oil base stock and a Group III/III+ oil base stock and/or a Group V oil base stock; optionally, providing a performance additive package; and optionally, blending the base oil with a performance additive package, thereby forming a wind turbine gear oil composition exhibiting one or more of the following, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or decreased wearing, determined by DIN ISO 14635-1 or DIN 51819-3; and equivalent or reduced oxidation, as determined by DIN EN ISO 4263-4.

Embodiment 15. A method for producing a wind turbine gear oil composition, the method comprising: providing a base oil for a wind turbine gear oil composition, the base oil comprising a Group II/II+ extra heavy neutral oil base stock and an additional oil base stock selected from a Group III/III+ oil base stock and/or a Group V oil base stock; optionally, providing a performance additive package; and optionally, blending the base oil with a performance additive package, thereby forming a wind turbine gear oil composition exhibiting, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

Embodiment 16. The method of Embodiment 14 or Embodiment 15, wherein the Group II/II+ extra heavy neutral oil base stock has: a kinematic viscosity at 40° C. (KV40), as determined by ASTM D445, of from 250 cSt to 600 cSt; a kinematic viscosity at 100° C. (KV100), as determined by ASTM D445, of from 15 cSt to 70 cSt; a viscosity index (VI), as determined by ASTM D2270, of from 80 to 120; and/or a pour point, as determined by ASTM D97, of from −50° C. to −10° C.

Embodiment 17. The method of any one of Embodiments 1416, wherein the additional oil base stock comprises a Group III/III+ oil base stock comprising at least one oil base stock selected from the group consisting of coal-to-liquid (CTL) oil base stocks, gas-to-liquid (GTL) oil base stocks, and any combination thereof.

Embodiment 18. The method of any one of Embodiments 14-17, wherein the Group III/III+ oil base stock is present at 30 weight percent (wt. %) or less, based on the total weight of the wind turbine gear oil composition.

Embodiment 19. The method of any one of Embodiments 14-18, wherein the Group V oil base stock comprising at least one oil base stock selected from the group consisting of esters, naphthalene compounds, polyoxyalkylene glycols (PAGs), esters thereof, ethers thereof, phosphates, and any combination thereof.

Embodiment 20. The method of any one of Embodiments 14-19, wherein the Group V oil base stock is present at from 10 wt. % or less, based on the total weight of the wind turbine gear oil composition.

Embodiment 21. The method of any one of Embodiments 14-20, wherein the performance additive package comprises at least one additive selected from the group consisting of antioxidants, antiwear agents, antifoam agents, demulsifiers, antirust agents, metal passivators, pour point depressants, and any combination thereof; and/or wherein the wind turbine gear oil composition comprises from 95 weight percent (wt. %) to 99 wt. % of the base oil, and/or from 1 wt. % to 5 wt. %, of the performance additive package, based on the total weight of the wind turbine gear oil composition.

Embodiment 22. The method of any one of Embodiments 14-21, wherein the base oil further comprises at least one additional oil base stock selected from a group consisting of Group II oil base stocks, Group II+ oil base stocks, Group IV oil base stocks, and any combination thereof.

Embodiment 23. The method of any one of Embodiments 14-22, wherein the wind turbine gear oil composition exhibits one or more of the following: a kinematic viscosity at 40° C. (KV40), as determined by DIN EN ISO 3104, of from 290 cSt to 320 cSt; a viscosity index (VI), as determined by DIN ISO 2909, of from 91 to 150; and a pour point, as determined by ASTM D97, of from −60° C. to −30° C.

Embodiment 24. The method of any one of Embodiments 14-23, wherein the wind turbine gear oil composition exhibits a property selected from the group consisting of: a kinematic viscosity at 40° C. (KV40), as determined by DIN EN ISO 3104, of from 290 cSt to 370 cSt; a pour point, as determined by ASTM D97, of from −50° C. to −30° C.; and any combination thereof.

Embodiment 25. The method of any one of Embodiments 14-24, wherein the wind turbine gear oil composition exhibits one or more of the following: a demulsibility at 82° C., as determined by DIN ISO 6614, of 10 minutes (min) to 20 min; and a kinematic viscosity at 100° C. (KV100) percent (%) increase at 121° C., as determined by DIN EN ISO 4263-4, of 2% or less.

Embodiment 26. The method of any one of Embodiments 14-25, wherein the wind turbine gear oil composition exhibits a property selected from the group consisting of: a demulsibility at 82° C., as determined by DIN ISO 6614, of 10 minutes (min) to 20 min; a kinematic viscosity at 100° C. (KV100) percent (%) increase at 121° C., as determined by DIN EN ISO 4263-4, of 2% or less; and any combination thereof.

Embodiment 27. A wind turbine gear oil composition, comprising: a base oil comprising a Group II/II+ extra heavy neutral oil base stock and an additional oil base stock selected from a Group III/III+ oil base stock and/or a Group V oil base stock, and a performance additive package; wherein: the Group II/II+ extra heavy neutral oil base stock is present in the wind turbine gear oil composition at from about 5 wt % to about 98 wt %; the Group III/III+ oil base stock is present in the wind turbine gear oil composition at from about 10 wt % to about 40 wt % and/or the Group V oil base stock is present in the wind turbine gear oil composition at from 1 wt % to about 10 wt %; the performance additive package is present in the wind turbine gear oil composition at from about 1 wt % to about 5 wt %; and the wind turbine gear oil composition exhibits, as compared to a corresponding wind turbine gear oil composition wherein at least 40% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

Embodiment 28. The wind turbine gear oil composition of Embodiment 27, wherein the Group II/II+ extra heavy neutral oil base stock has: a kinematic viscosity at 40° C. (KV40), as determined by ASTM D445, of from 250 cSt to 600 cSt; a kinematic viscosity at 100° C. (KV100), as determined by ASTM D445, of from 15 cSt to 70 cSt; a viscosity index (VI), as determined by ASTM D2270, of from 80 to 120; and/or a pour point, as determined by ASTM D97, of from −50° C. to −10° C.

Embodiment 29. The wind turbine gear oil composition of Embodiment 27 or Embodiment 28, wherein the additional oil base stock comprises the Group III/III+ oil base stock, which comprises at least one oil base stock selected from the group consisting of coal-to-liquid (CTL) oil base stocks, gas-to-liquid (GTL) oil base stocks, and any combination thereof.

Embodiment 30. The wind turbine gear oil composition of any one of Embodiments 27-29, wherein the additional oil base stock comprises the Group V oil base stock, which comprises at least one oil base stock selected from the group consisting of esters, naphthalene compounds, polyoxyalkylene glycols (PAGs), esters thereof, ethers thereof, phosphates, and any combination thereof.

Embodiment 31. The wind turbine gear oil composition of any one of Embodiments 27-30, wherein the additional oil base stock comprises the Group V oil base stock, which comprises an alkylated naphthalene, a ditridecyl adipate ester, or a combination thereof.

Embodiment 32. The wind turbine gear oil composition of any one of Embodiments 27-31, wherein the performance additive package comprises at least one additive selected from the group consisting of antioxidants, antiwear agents, antifoam agents, demulsifiers, antirust agents, metal passivators, pour point depressants, and any combination thereof.

Embodiment 33. The wind turbine gear oil composition of any one of Embodiments 27-32, wherein the base oil further comprises at least one oil base stock selected from the group consisting of Group II oil base stocks, Group II+ oil base stocks, Group IV oil base stocks, and any combination thereof.

Embodiment 34. The wind turbine gear oil composition of Embodiment 33, wherein the base oil comprises the Group IV oil base stock, which comprises at least one oil base stock selected from the group consisting of conventional polyalphaolefin (PAO) oil base stocks, metallocene PAO oil base stocks, and any combination thereof, wherein the Group IV oil base stock is present in the wind turbine gear oil composition at from about 30 wt % to about 70 wt %.

Embodiment 35. The wind turbine gear oil composition of any one of Embodiments 27-34, wherein the wind turbine gear oil composition exhibits a property selected from the group consisting of: a kinematic viscosity at 40° C. (KV40), as determined by DIN EN ISO 3104, of from 290 cSt to 370 cSt; a viscosity index (VI), as determined by DIN ISO 2909, of from 150 to 185, a pour point, as determined by ASTM D97, of from −50° C. to −30° C.; and any combination thereof.

Embodiment 36. The wind turbine gear oil composition of any one of Embodiments 27-35, wherein the wind turbine gear oil composition exhibits a property selected from the group consisting of: a demulsibility at 82° C., as determined by DIN ISO 6614, of 10 minutes (min) to 20 min; a kinematic viscosity at 100° C. (KV100) percent (%) increase at 121° C., as determined by DIN EN ISO 4263-4, of 2% or less; and any combination thereof.

Embodiment 37. A method for producing a wind turbine gear oil composition, the method comprising: providing a base oil for a wind turbine gear oil composition, the base oil comprising a Group II/II+ extra heavy neutral oil base stock and an additional oil base stock selected from a Group III/III+ oil base stock and/or a Group V oil base stock; providing a performance additive package; and blending the base oil with the performance additive package, thereby forming a wind turbine gear oil composition, wherein: the Group II/II+ extra heavy neutral oil base stock is present in the wind turbine gear oil composition at from about 5 wt % to about 98 wt %; the Group III/III+ oil base stock is present in the wind turbine gear oil composition at from about 10 wt % to about 40 wt % and/or the Group V oil base stock is present in the wind turbine gear oil composition at from 1 wt % to about 10 wt %; the performance additive package is present in the wind turbine gear oil composition at from about 1 wt % to about 5 wt %; and the wind turbine gear oil composition exhibits, as compared to a corresponding wind turbine gear oil composition wherein at least 60% of the Group II/II+ extra heavy neutral oil base stock is replaced with a Group IV oil base stock and the balance of the Group II/II+ extra heavy neutral oil base stock is replaced with the Group III/III+ oil base stock and/or the Group V oil base stock, a property selected from the group consisting of: equivalent or reduced copper corrosion, determined by DIN EN ISO 2160; equivalent or reduced rust formation, determined by DIN ISO 7120; equivalent or reduced pour point, determined by DIN ISO 3016; equivalent or increased demulsibility, determined by DIN ISO 6614; equivalent or decreased foaming, determined by ISO 12152; equivalent or reduced oxidation, as determined by DIN EN ISO 4263-4; and any combination thereof.

Embodiment 38. The method of Embodiment 37, wherein the Group II/II+ extra heavy neutral oil base stock has: a kinematic viscosity at 40° C. (KV40), as determined by ASTM D445, of from 250 cSt to 600 cSt; a kinematic viscosity at 100° C. (KV100), as determined by ASTM D445, of from 15 cSt to 70 cSt; a viscosity index (VI), as determined by ASTM D2270, of from 80 to 120; and/or a pour point, as determined by ASTM D97, of from −50° C. to −10° C.

Embodiment 39. The method of Embodiment 37 or Embodiment 38, wherein the additional oil base stock comprises the Group III/III+ oil base stock, which comprises at least one oil base stock selected from the group consisting of coal-to-liquid (CTL) oil base stocks, gas-to-liquid (GTL) oil base stocks, and any combination thereof.

Embodiment 40. The method of any one of Embodiments 37-39, wherein the additional oil base stock comprises the Group V oil base stock, which comprises at least one oil base stock selected from the group consisting of esters, naphthalene compounds, polyoxyalkylene glycols (PAGs), esters thereof, ethers thereof, phosphates, and any combination thereof.

Embodiment 41. The method of any one of Embodiments 37-40, wherein the additional oil base stock comprises the Group V oil base stock, which comprises an alkylated naphthalene, a ditridecyl adipate ester, or a combination thereof.

Embodiment 42. The method of any one of Embodiments 37-41, wherein the performance additive package comprises at least one additive selected from the group consisting of antioxidants, antiwear agents, antifoam agents, demulsifiers, antirust agents, metal passivators, pour point depressants, and any combination thereof.

Embodiment 43. The method of any one of Embodiments 37-42, wherein the base oil further comprises at least one additional oil base stock selected from a group consisting of Group II oil base stocks, Group II+ oil base stocks, Group IV oil base stocks, and any combination thereof.

Embodiment 44. The method of Embodiment 43, wherein the base oil comprises a Group IV oil base stock comprising at least one oil base stock selected from the group consisting of conventional polyalphaolefin (PAO) oil base stocks, metallocene PAO oil base stocks, and any combination thereof, wherein the Group IV oil base stock is present in the wind turbine gear oil composition at from about 30 wt % to about 70 wt %.

Embodiment 45. The method of any one of Embodiments 37-44, wherein the wind turbine gear oil composition exhibits a property selected from the group consisting of: a kinematic viscosity at 40° C. (KV40), as determined by DIN EN ISO 3104, of from 290 cSt to 370 cSt; and a viscosity index (VI), as determined by DIN ISO 2909, of from 150 to 185, a pour point, as determined by ASTM D97, of from −50° C. to −30° C.; and any combination thereof.

Embodiment 46. The method of any one of Embodiments 37-45, wherein the wind turbine gear oil composition exhibits a property selected from the group consisting of: a demulsibility at 82° C., as determined by DIN ISO 6614, of 10 minutes (min) to 20 min; a kinematic viscosity at 100° C. (KV100) percent (%) increase at 121° C., as determined by DIN EN ISO 4263-4, of 2% or less; and any combination thereof.

### EXAMPLES

### Example 1

Wind turbine gear oils are almost exclusively manufactured from Group IV and Group V materials due to the demanding nature of the wind application. Until recently, these were the only materials that were capable of providing the required oxidation (oil life) and low temperature properties. However, it has surprisingly been found that a wind turbine gear oil composition comprises a minimal amount of a Group V oil base stock (<5%), a gear oil additive system, and the balance being almost exclusively (95%+) API Group II/II+ extra heavy neutral oil base stock (e.g., EHC 340 MAX™, ExxonMobil Corporation) and Group III oil base stock, equivalent or improved results are exhibited in a wide range of lubricant performance tests, as compared to a corresponding wind turbine gear oil composition comprising almost exclusively Group IV oil base stock. These tests cover many performance areas, including: copper corrosion, rust, water separability (demulsibility), pour point, foam, and oxidation stability and deposits. This composition is advantaged as API Group II/III base oils are much easier and less energy intensive to manufacture than API Group IV base oils. This composition would be a step change for the industry and unlock significant value for oil manufacturers and gearbox operators. The following is an inventive example formulation, however additional embodiments would be apparent to one skilled in the art.

Especially surprising are the ASTM D97 pour point results being equivalent (test is +3° C.), as PAO is known to have exceptional low temperature performance (with mPAO having superior low temperature performance to conventional PAO). Table 1 gives the components of the wind turbine engine oil compositions tested, including a control example (CE) and an inventive example (IE).

TABLE 1

| Wind Turbine Gear Oil Composition Components | CE | IE |
|---|---|---|
| Group III/III+: Qatar GTL QHVI ™ 8 (GTL 8) | 30 | 10.1 |
| Group IV: SPECTRASYN ™ Elite 150 (mPAO 150) | 62.2 | — |
| Group V: SYNESSTIC ™ 5 (Alkylated Naphthalene) | — | 3 |
| Group V: ESTEREX ™ A51 (Ditridecyl Adipate Ester) | 6 | — |
| Group II/II+ Extra Heavy Neutral: ECH 340 MAX ™ | — | 85 |
| Performance Additive Package (PAP) | 1.8 | — |
| (no Pour Point Depressant) | | |
| PAP (with Pour Point Depressant: Viscoplex ® 1-333) | — | 1.9 |
| Total | 100 | 100 |

Optionally, Group V oil base stocks can be used. These include, but are not limited to, esters (e.g., adipate esters) and alkylated aromatics (e.g., alkylated naphthalene compounds). The Group V oil base stocks can be added at 3 weight % (wt. %) to 15 wt. %, e.g., at less than 5 wt. %, such as at 3 wt. %.

A typical additive package for a wind turbine gear oil may contain: an antioxidant, an antiwear agent, an antifoam agent, a demulsifier, an antirust agent, a metal passivator, and a pour point depressant. The package can range from 1 wt. %-5 wt. %, optimally 1.5 wt. %-3 wt. %.

Table 2 gives the results of the wind turbine engine oil compositions tested. The following requirements are those necessary for a DIN 51517-3 Gear oil specification which is a minimum requirement for wind turbine gear oils. As can be seen from the table, each of the control (CE) and the inventive (IE) formulations meet these requirements easily. (Note: Certain categories, e.g., for density, total acid number (TAN), and FE8 cage wear, the only requirement is to report the results). The key standout performance properties include the result for pour point where the invention formulation outperforms the control formulation (comprising a majority of API Group IV oil base stock). Additionally, the inventive formulation provides surprisingly comparable oxidation performance as seen in the DIN EN ISO 4263-4 KV100% increase result.

TABLE 2

| Category | Number | Unit | Limit | CE | IE |
|---|---|---|---|---|---|
| Viscosity, KV40 | DIN EN ISO 3104 | cSt | 288-352 | 347 | 298 |
| Viscosity, VI | DIN ISO 2909 | — | >90 | 184 | 104 |
| Density | DIN 51757 | g/mL | Report | 0.848 | 0.875 |
| Flash Point | DK EN ISO 2592 | ° C. | >200 | 262 | 299 |
| Pour Point | DIN ISO 3016 | ° C. | <−9 | −39 | −48 |
| Total Acid Number (TAN) | DIN ISO 6618 | mg KOH/g | Report | 0.7 | 0.6 |
| Water Content | DIN 51777-2 | ppm | <0.1% | 130 | 71 |
| Flender Foam (Total) | ISO 12152 | % | <15 | 6 | 10 |
| Flender Foam (Oil-Air) | ISO 12152 | % | <10 | 1 | 6 |
| Demulsibility | DIN ISO 6614, 82° C. | min | <30 | 20 | 15 |
| Copper Corrosion | DIN EN ISO 2160, | lb | 1 | 1 | 1 |
| | 100° C., 3 hrs | | | | |
| Rust (DI Water) | DIN ISO 7120 | Rating | PASS | PASS | PASS |
| Oxidation KV100 Increase | DIN EN ISO 4263-4 | % | <6 | 0 | 0.5 |
| Oxidation Precipitation # | DIN EN ISO 4263-4 | mL | <0.1 | <0.1 | <0.1 |
| FZG Scuffing | DIN ISO 14635-1 | Failure | 12 | >12 | >12 |
| | | Load Stage | | | |
| FE8 Roller Wear | DIN 51819-3 | mg | <30 | 0 | 0 |
| FE8 Cage Wear | DIN 51819-3 | mg | Report | 208 | 111 |

In summary, the present example describes a method to achieve equivalent or improved performance by substituting the Group IV oil base stock of a wind turbine gear oil composition with a Group II/II+ extra heavy neutral oil base stock, and compositions to achieve this.

### Example 2

Further studies of wind turbine gear oil compositions were performed. Table 3 below gives the components of the control example (CE) and four inventive examples (IE1 to IE4).

TABLE 3

| Wind Turbine Gear Oil Composition | | | | | |
|---|---|---|---|---|---|
| Components | CE | IE1 | IE2 | IE3 | IE4 |
| Group III/III+: Qatar GTL QHVITM 8 (GTL 8) | 30 | 30 | 30 | 20 | 20 |
| Group IV: SPECTRASYNTM Elite 150 (mPAO 150) | 62.2 | 55.1 | 45.1 | 40.1 | 35.1 |
| Group V: SYNESSTICTM 5 (Alkylated Naphthalene) | 0 | 3 | 3 | 3 | 3 |
| Group V: ESTEREXTM A51 (Ditridecyl Adipate Ester) | 6 | | | | |
| Group II/II+ Extra Heavy Neutral: EHC 340 MAXTM | 0 | 10 | 20 | 35 | 40 |
| Performance Package Additive (PAP-1) | 1.8 | | | | |
| (no Pour Point Depressant) | | | | | |
| PAP-2 (with Pour Point Depressant: | | 1.9 | 1.9 | 1.9 | 1.9 |
| Viscoplex ® 1-333) | | | | | |
| Total | 100 | 100 | 100 | 100 | 100 |

The performance additive package PAP-1 contained an antioxidant, an antiwear agent, an antifoam agent, a demulsifier, and a metal passivator. The performance additive package PAP-2 contained an antioxidant, an antiwear agent, an antifoam agent, a demulsifier, a metal passivator, and pour point depressant (Viscoplex® 1-333).

Viscosity properties determined for the control example and the inventive examples were KV40, determined by DIN EN ISO 3104; KV100, determined by DIN EN ISO 3104; and VI, determined by DIN ISO 2909.

Pour point for the control example and the inventive examples was determined by DIN ISO 3016.

Copper corrosion for the control example and the inventive examples was determined by DIN EN ISO 2160, 100° C., 3 hrs.

Rust test for the control example and the inventive examples was determined by DIN ISO 7120.

Total acid number for the control example and the inventive examples was determined by DIN ISO 6618.

Demulsibility for the control example and the inventive examples was determined by DIN ISO 6614, 82° C.

Oxidation for the control example and the inventive examples was assessed as KV100 Increase, determined by DIN EN ISO 4263-4.

Table 4 below gives the test results for wind turbine gear oil compositions tested.

TABLE 4

| Category | Test | CE | IE1 | IE2 | IE3 | IE4 |
|---|---|---|---|---|---|---|
| Viscosity | DIN EN ISO 3104, KV40 (cSt) | 347 | 341.6 | 297.7 | 362.2 | 338.6 |
| | DIN EN ISO 3104, KV100 (cSt) | | 41.56 | 35.26 | 38.2 | 35.42 |
| | DIN ISO 2909, VI | 185 | 176 | 165 | 154 | 150 |
| Pour Point | DIN ISO 3016 (° C.) | −39 | −45 | −39 | −36 | −39 |
| Copper Corrosion | DIN EN ISO 2160, | 1A | n.d. | 1A | 1A | n.d. |
| | 100° C., 3 hrs (Rating) | | | | | |
| Rust Test | DIN ISO 7120 (Rating) | PASS | n.d. | PASS | PASS | n.d. |
| Total Acid Number | DIN ISO 6618 (mg KOH/g) | 0.7 | n.d. | 0.55 | 0.55 | n.d. |
| (TAN) | | | | | | |
| Demulsibility | DIN ISO 6614, 82° C. (min) | 20 | n.d. | 15 | 15 | n.d. |
| Oxidation (KV100 | DIN EN ISO 4263-4 (%) | 0 | 1.49 | 0.7 | 1.1 | 0.9. |
| Increase) | | | | | | |

n.d., not determined.

While various embodiments have been shown and described herein, modifications may be made by one skilled in the art without departing from the scope of the present disclosure. The embodiments described herein are exemplary only and are not intended to be limiting. Many variations, combinations, and modifications of the embodiments disclosed herein are possible and are within the scope of the disclosure. Accordingly, the scope of protection is not limited by the description set out above, but is defined by the claims that follow, that scope including all equivalents of the subject matter of the claims.

Therefore, the present disclosure is well adapted to attain the ends and advantages mentioned as well as those that are inherent therein. The particular examples and configurations disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present disclosure. The disclosure illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about A to about B,” or, equivalently, “from approximately A to B,” or, equivalently, “from approximately A-B”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

Unless otherwise indicated, all numbers expressing quantities of ingredients, properties, such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present disclosure. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more disclosed elements are presented herein. Not all features of a physical implementation are described or shown in this application for the sake of clarity. It is understood that in the development of a physical embodiment incorporating one or more elements of the present disclosure, numerous implementation-specific decisions must be made to achieve the developer's goals, such as compliance with system-related, business-related, government-related, and other constraints, which vary by implementation and from time to time. While a developer's efforts might be time consuming, such efforts would be, nevertheless, a routine undertaking for those of ordinary skill in the art and having benefit of this disclosure.

The invention as claimed is:

1. A wind turbine gear oil composition, comprising:
a base oil comprising a Group II/II+ extra heavy neutral oil base stock and an additional oil base stock selected from a Group III/III+ oil base stock and/or a Group V oil base stock, and
a performance additive package;
wherein the wind turbine gear oil composition exhibits, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of:
equivalent or reduced copper corrosion, determined by DIN EN ISO 2160;
equivalent or reduced rust formation, determined by DIN ISO 7120;
equivalent or reduced pour point, determined by DIN ISO 3016;
equivalent or increased demulsibility, determined by DIN ISO 6614;
equivalent or decreased foaming, determined by ISO 12152;
equivalent or reduced oxidation, as determined by DIN EN ISO 4263-4; and
any combination thereof.

2. The wind turbine gear oil composition of claim 1, wherein the Group II/II+ extra heavy neutral oil base stock has:
a kinematic viscosity at 40° C. (KV40), as determined by ASTM D445, of from 250 cSt to 600 cSt;
a kinematic viscosity at 100° C. (KV100), as determined by ASTM D445, of from 15 cSt to 70 cSt;
a viscosity index (VI), as determined by ASTM D2270, of from 80 to 120; and/or
a pour point, as determined by ASTM D97, of from −50° C. to −10° C.

3. The wind turbine gear oil composition of claim 1, wherein the additional oil base stock comprises a Group III/III+ oil base stock comprising at least one oil base stock selected from the group consisting of coal-to-liquid (CTL) oil base stocks, gas-to-liquid (GTL) oil base stocks, and any combination thereof.

4. The wind turbine gear oil composition of claim 1, wherein the Group III/III+ oil base stock is present at 30 weight percent (wt. %) or less, based on the total weight of the wind turbine gear oil composition.

5. The wind turbine gear oil composition of claim 1, wherein the Group V oil base stock comprising at least one oil base stock selected from the group consisting of esters, naphthalene compounds, polyoxyalkylene glycols (PAGs), esters thereof, ethers thereof, phosphates, and any combination thereof.

6. The wind turbine gear oil composition of claim 1, wherein the Group V oil base stock is present at from 10 wt. % or less, based on the total weight of the wind turbine gear oil composition.

7. The wind turbine gear oil composition of claim 1, wherein the performance additive package comprises at least one additive selected from the group consisting of antioxidants, antiwear agents, antifoam agents, demulsifiers, antirust agents, metal passivators, pour point depressants, and any combination thereof; and/or
wherein the wind turbine gear oil composition comprises from 95 weight percent (wt. %) to 99 wt. %, of the base oil, and/or from 1 wt. % to 5 wt. %, of the performance additive package, based on the total weight of the wind turbine gear oil composition.

8. The wind turbine gear oil composition of claim 1, wherein the base oil further comprises at least one additional oil base stock selected from a group consisting of Group II oil base stocks, Group II+ oil base stocks, Group IV oil base stocks, and any combination thereof.

9. The wind turbine gear oil composition of claim 1, wherein the wind turbine gear oil composition exhibits a property selected from the group consisting of:
a kinematic viscosity at 40° C. (KV40), as determined by DIN EN ISO 3104, of from 290 cSt to 370 cSt;
a pour point, as determined by ASTM D97, of from −50° C. to −30° C.; and
any combination thereof.

10. The wind turbine gear oil composition of claim 1, wherein the wind turbine gear oil composition exhibits a property selected from the group consisting of:
a demulsibility at 82° C., as determined by DIN ISO 6614, of 10 minutes (min) to 20 min;
a kinematic viscosity at 100° C. (KV100) percent (%) increase at 121° C., as determined by DIN EN ISO 4263-4, of 2% or less; and
any combination thereof.

11. A method for producing a wind turbine gear oil composition, the method comprising:
providing a base oil for a wind turbine gear oil composition, the base oil comprising a Group II/II+ extra heavy neutral oil base stock and an additional oil base stock selected from a Group III/III+ oil base stock and/or a Group V oil base stock;
optionally, providing a performance additive package; and
optionally, blending the base oil with a performance additive package,
thereby forming a wind turbine gear oil composition exhibiting, as compared to a corresponding wind turbine gear oil composition wherein all of the Group II/II+ extra heavy neutral oil base stock is replaced with a Group IV oil base stock and, optionally, a Group III/III+ oil base stock and/or a Group V oil base stock, a property selected from the group consisting of:
equivalent or reduced copper corrosion, determined by DIN EN ISO 2160;
equivalent or reduced rust formation, determined by DIN ISO 7120;
equivalent or reduced pour point, determined by DIN ISO 3016;
equivalent or increased demulsibility, determined by DIN ISO 6614;
equivalent or decreased foaming, determined by ISO 12152;
equivalent or reduced oxidation, as determined by DIN EN ISO 4263-4; and
any combination thereof.

12. The method of claim 11, wherein the Group II/II+ extra heavy neutral oil base stock has:
a kinematic viscosity at 40° C. (KV40), as determined by ASTM D445, of from 250 cSt to 600 cSt;
a kinematic viscosity at 100° C. (KV100), as determined by ASTM D445, of from 15 cSt to 70 cSt;
a viscosity index (VI), as determined by ASTM D2270, of from 80 to 120; and/or
a pour point, as determined by ASTM D97, of from −50° C. to −10° C.

13. The method of claim 11, wherein the additional oil base stock comprises a Group III/III+ oil base stock comprising at least one oil base stock selected from the group consisting of coal-to-liquid (CTL) oil base stocks, gas-to-liquid (GTL) oil base stocks, and any combination thereof.

14. The method of claim 11, wherein the Group III/III+ oil base stock is present at 30 weight percent (wt. %) or less, based on the total weight of the wind turbine gear oil composition.

15. The method of claim 11, wherein the Group V oil base stock comprising at least one oil base stock selected from the group consisting of esters, naphthalene compounds, polyoxyalkylene glycols (PAGs), esters thereof, ethers thereof, phosphates, and any combination thereof.

16. The method of claim 11, wherein the Group V oil base stock is present at from 10 wt. % or less, based on the total weight of the wind turbine gear oil composition.

17. The method of claim 11, wherein the performance additive package comprises at least one additive selected from the group consisting of antioxidants, antiwear agents, antifoam agents, demulsifiers, antirust agents, metal passivators, pour point depressants, and any combination thereof; and/or
wherein the wind turbine gear oil composition comprises from 95 weight percent (wt. %) to 99 wt. % of the base oil, and/or from 1 wt. % to 5 wt. %, of the performance additive package, based on the total weight of the wind turbine gear oil composition.

18. The method of claim 11, wherein the base oil further comprises at least one additional oil base stock selected from a group consisting of Group II oil base stocks, Group II+ oil base stocks, Group IV oil base stocks, and any combination thereof.

19. The method of claim 11, wherein the wind turbine gear oil composition exhibits a property selected from the group consisting of:
a kinematic viscosity at 40° C. (KV40), as determined by DIN EN ISO 3104, of from 290 cSt to 370 cSt;
a pour point, as determined by ASTM D97, of from −50° C. to −30° C.; and
any combination thereof.

20. The method of claim 11, wherein the wind turbine gear oil composition exhibits a property selected from the group consisting of:
a demulsibility at 82° C., as determined by DIN ISO 6614, of 10 minutes (min) to 20 min;
a kinematic viscosity at 100° C. (KV100) percent (%) increase at 121° C., as determined by DIN EN ISO 4263-4, of 2% or less; and
any combination thereof.
